(19) United States
(12) Patent Application Publication
(10) Pub. No.: US 2023/0409882 A1
(43) Pub. Date: Dec. 21, 2023

(54) EFFICIENT PROCESSING OF TRANSFORMER BASED MODELS

(71) Applicants: Ibrahim Ahmed, Mississauga (CA); Sahil Parmar, Newark, CA (US); Matthew Thomas Boyd, Bend, OR (US)

(72) Inventors: Ibrahim Ahmed, Mississauga (CA); Sahil Parmar, Newark, CA (US); Matthew Thomas Boyd, Bend, OR (US)

(21) Appl. No.: 18/336,589

(22) Filed: Jun. 16, 2023

Related U.S. Application Data
(60) Provisional application No. 63/353,496, filed on Jun. 17, 2022.

(51) Int. Cl. G06N 3/0455; G06F 17/16

(52) U.S. Cl. CPC G06N 3/0455; G06F 17/16

(57) ABSTRACT

Facilitating efficient processing of transformer based models is provided herein. A low latency processing system includes a transformer having an embedding layer and a Tensor Streaming Processor (TSP) having a Matrix Multiplication module (MXM) and Vector Calculation module (VXM). The TSP is arranged to deterministically process information arranged by the embedding layer and an encoder layer with the associated self-attention mechanism, the information being further modified according to the transformer using a general matrix multiply (GEMM) mapped directly on the MXM and associated accumulator. Further, at least some set of information is processed to parallelize the execution of GEMMs across all MXM planes.

### RELATED APPLICATIONS

This application claims the benefit of priority to U.S. Provisional Application No. 63/353,496 filed Jun. 17, 2022, titled “Answer Fast: Accelerating BERT on the Tensor Streaming Processor,” which is incorporated by reference in its entirety.

### COPYRIGHT NOTICE

This patent document can be exactly reproduced as it appears in the files of the United States Patent and Trademark Office, but the assignee(s) otherwise reserves all rights in any subsets of included original works of authorship in this document protected by 17 USC 102(a) of the U.S. copyright law.

### SPECIFICATION—DISCLAIMERS

In the following Background, Summary, and Detailed Description, paragraph headings are signifiers that do not limit the scope of an embodiment of a claimed invention. The citation or identification of any publication signifies neither relevance nor use as prior art.

A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### TECHNICAL FIELD

The present disclosure generally relates to low latency operation of transformers or components of large language models on a tensor streaming processor architecture.

### BACKGROUND

Recently processor based systems, that rely on GPUs and CPUs, have been used to deploy large language models, such as transformers. Transformers have gained immense popularity because of their performance on various natural language processing (NLP) tasks. The combination of impressive performance, contextual understanding and language generation capabilities has contributed to the widespread use of such transformer based AI models. They have revolutionized the NLP field and paved the way for exciting applications in various domains, including virtual assistants, chatbots, sentiment analysis, language translation, and much more.

Unfortunately, many available processor based systems have latency issues that prevent real time use when transformer based models are deployed for actual use. Although these systems are adequate for performing the necessary calculations, their architectures require greatly increased time to execute a transformer model. Systems and methods that can support low latency operation of transformers or components of large language models (LLM) are needed.

### SUMMARY

Embodiments of the claimed inventions can involve operation of one or more Tensor Streaming Processor(s) (TSP). Tensor computations (typically computations on vectors and matrices) are performed using a streaming process model where computational tiles, and data storage and switching tiles, are interconnected for data transfers between tiles to take advantage of dataflow locality as elements of tensors flowing through the architecture to be calculated upon. Multiple TSPs can be connected together, and computations can be divided between multiple TSP processing systems.

This disclosure describes a low latency data processing system that includes a transformer model having an embedding layer and an encoder layer with an associated self-attention block. The transformer module can operate on a Tensor Streaming Processor (TSP) having a Matrix Multiplication module (MXM) and Vector Calculation module (VXM). In some embodiments the TSP is arranged to deterministically process information arranged by the embedding layer and the encoder layer with the associated self-attention mechanism, the information being further modified according to the transformer model using a general matrix multiply (GEMM) mapped directly on the MXM and associated accumulator, and wherein at least some set of information is processed to parallelize the execution of GEMMs across all MXM planes.

In some embodiments the transformer is a part of a language representation model (LLM).

In some embodiments the transformer is a part of a Bidirectional Encoder Representations from Transformers (BERT) model.

In some embodiments the transformer is a part of a Generative Pre-trained Transformer (GPT) model.

In some embodiments the transformer is a part of Large Language Model Meta AI (LLaMA) model. According to some embodiments, the transformer is an encoder only, a decoder only, or an encoder/decoder model based on the transformer architecture.

In some embodiments the encoder layer has multiple encoders and further accepts positional information.

In some embodiments the self-attention mechanism further includes multi-head attention modules associated with multiple encoders.

In some embodiments output from the associated self-attention mechanism is passed to a feed-forward layer and modified using a Gaussian Error Linear Unit (GELU) that can be mapped onto the VXM.

In some embodiments the TSP further comprises Memory modules (MEM) and data path switching modules (SXM), and wherein a vector can be read from the MEM, reordered on the SXM, passed to the MXM, sent to the VXM, modified by a softmax pass and written to MEM. In some embodiments the TSP is software scheduled.

Embodiments of the claimed inventions rely on operation of a Tensor Streaming Processor (TSP). Tensor computations (typically computations on vectors and matrices) are performed using a streaming process model where computational tiles, and data storage and switching tiles, are interconnected for data transfers between tiles in a Superlane structure, to take advantage of dataflow locality as elements of tensors flowing through the architecture to be calculated upon.

### BRIEF DESCRIPTION OF THE DRAWINGS

FIG. 1 illustrates a computing system supporting a transformer model on a Tensor Streaming Processor (TSP).

FIG. 2 illustrates a representative BERT (Bidirectional Encoder Representations from Transformers) transformer model.

FIG. 3 illustrates a computing system supporting small embeddings into a transformer model on a TSP.

FIG. 4 illustrates a computing system supporting software scheduled deterministic processing of a transformer model on a TSP.

FIGS. 5-15 illustrate in more detail the operation of a BERT transformer model on the TSP which has memory (MEM), path switching (SXM) and matrix and vector multiplication (MXM, VXM) modules.

FIG. 16 depicts a Superlane of the TSP comprised of multiple tiles.

FIG. 17 depicts data flow in a Superlane.

FIG. 18 depicts multiple Superlanes partitioned into slices.

FIG. 19 depicts a system of controlling host computers and a set of TSPs, with multiple communication links.

FIG. 20 depicts the architecture and data flow of an MXM multiplication tile.

FIG. 21 depicts a TSP partitioned into two processing halves.

FIG. 22 depicts a Superlane with embedded stream registers.

FIG. 23 depicts streams organized by lanes.

FIG. 24 depicts two sets of streams flowing in different directions.

FIG. 25 depicts the different operations (read, write, transpose, rotate, etc.) in a max pooling operation.

FIG. 26 depicts a network of TSP processors connected via Chip-to-Chip modules.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The following are brief definitions of important terms that are further described in subsequent paragraphs.

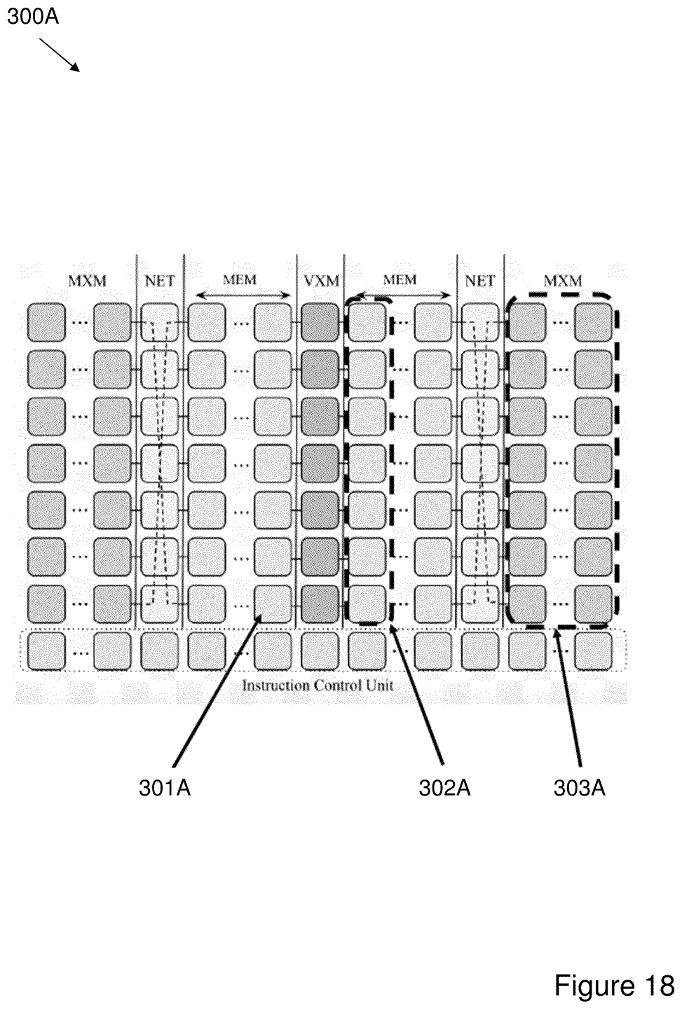

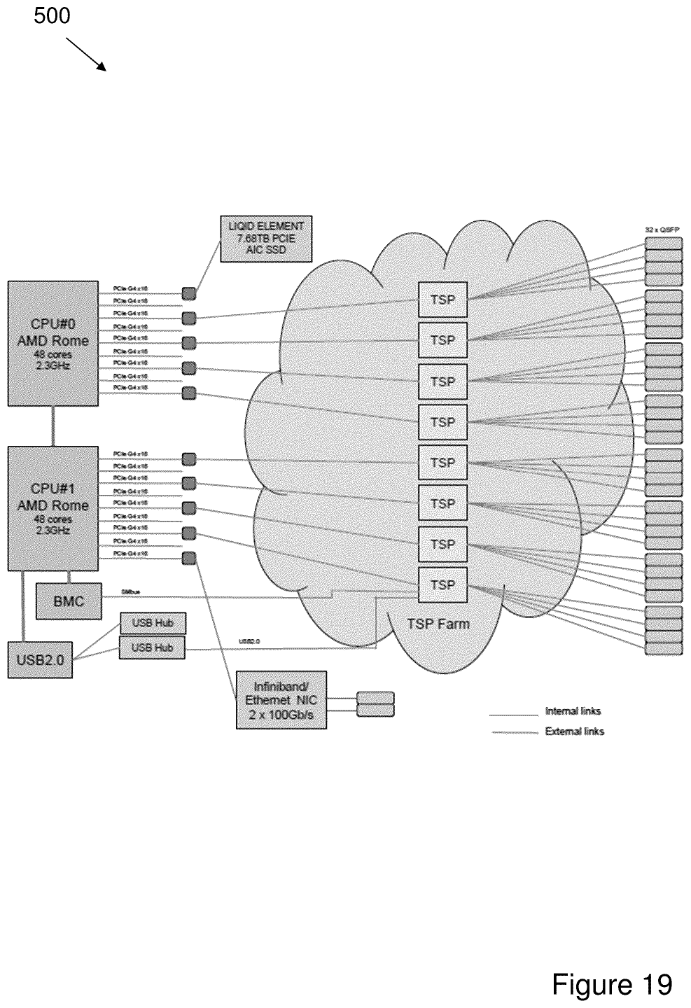

The fundamental modules of a TSP are herein referred to as ‘tiles’. For example, one tile is depicted as element 301A in FIG. 18. The tiles perform different functions such as vector-matrix multiplication, switching of data along different circuit pathways, and local data storage and retrieval. Typically, tiles share a common system clock. A set of interconnected tiles processing the same set of data is referred to herein as a ‘Superlane’. Each tile in a Superlane can be_subdivided into 16 sub-tiles, referred to herein as ‘lanes’. A set of tiles with the same functionality executing the same instructions, located in similar positions in different Superlanes, is referred to herein as a ‘slice’, where the instructions are supplied from buffers that comprise an Instruction Control Unit (ICU). A set of directly connected slices of the same functional modules, encompassing all the Superlanes, is referred to herein as a ‘partition’. A set of data that is processed by one Superlane is referred to herein as a ‘stream’.

The TSP can support various data processing activities, including but not limited to transformer models that include encoding layers that process the input iteratively one layer after another. Additionally, in some embodiments a decoder having decoding layers can be connected to the encoder layer output. In operation, each encoder layer can generate encodings that contain relational or contextual information derived from inputs. Each decoder layer receives the encodings and uses that information to generate an output sequence with the aid of an attention mechanism. For each part of the input, an attention mechanism weighs the relevance to produce the output. In some embodiments, each decoder layer can also have an additional attention mechanism that draws information from the outputs of previous decoders, typically occurring before the decoder layer receives information from the encoding layer. Both the encoder and decoder layers can use a feed-forward neural network for processing.

Transformer models can be used to support various applications including machine translation, natural language processing, document summarization, document generation, web search, question and answer systems, speech recognition, and video or vision processing. Examples include Generative Pre-trained Transformer (GPT), GPT-2, GPT-3, GPT-4, Large Language Model Meta AI (LLaMA), BERT, XLNet, or RoBERTa.

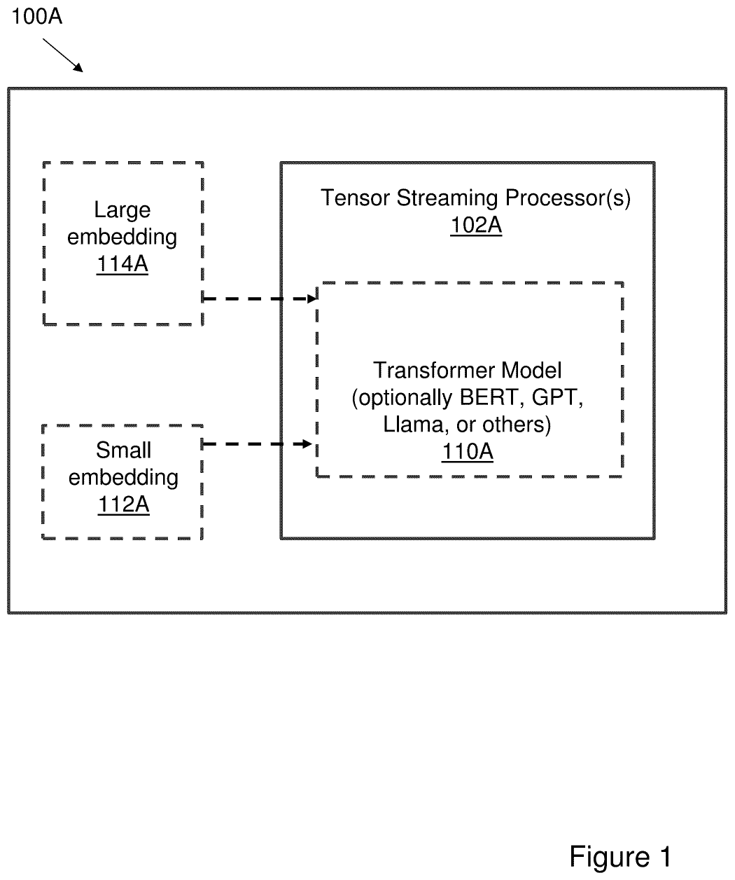

FIG. 1 illustrates a computing system 100A supporting a transformer model 110A that can execute on an accelerator such as a Tensor Streaming Processor (TSP) 102A commercially available from Groq, Inc. Mountain View, California. The TSP is a deterministic processor and is typically utilized as an accelerator that works in conjunction with a host computer. Modification or update of the transformer model 110A can be accomplished with a small embedding module 112A or a large embedding module 114A. Modules 112A and 114A can operate separately on a host processor 101A or can alternatively, or in addition, operate on the TSP 102A.

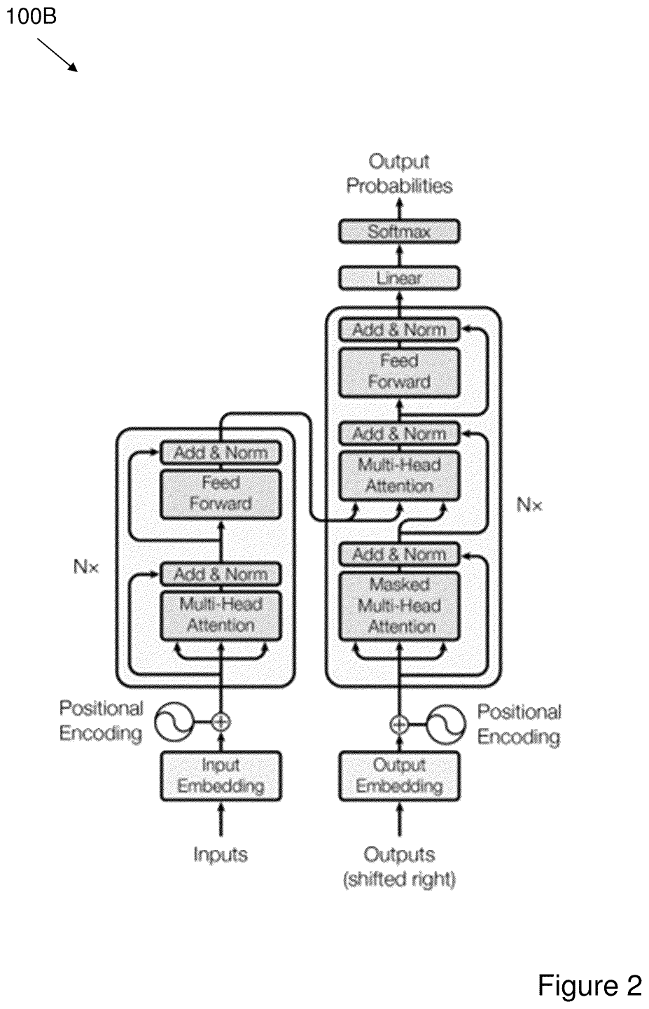

FIG. 2 illustrates a representative transformer model 100B able to operate on a TSP. Optionally, in one embodiment the transformer model illustrated in 100A and 100B is known as BERT (Bidirectional Encoder Representations from Transformers), and is described in a paper by Vaswani, A.; Shazeer, N.; Parmar, N.; Uszkoreit, J.; Jones, L.; Gomez, A. N.; Kaiser, L.; Polosukhin, I. Attention is all you need. In Proceedings of the Advances in Neural Information Processing Systems, Long Beach, CA, USA, 4-9 Dec. 2017; pp. 5998-6008, the disclosure of which is fully incorporated by reference.

As seen in FIG. 2, transformer model 100B, such as BERT, can include an input embedding layer, encoder and decoder stack, multi-head attention functionality, and an output layer. In transformer-based models, words or tokens can be initially represented as high-dimensional vectors known as word embeddings. These embeddings capture semantic and contextual information of the words in a dense vector space. Each dimension of the embedding vector represents a learned feature or property of the word. The choice of embedding size is a trade-off between model performance and resource constraints. While larger embeddings can provide richer representations, they require more memory and computational resources. The selection of the embedding size depends on factors such as the specific task, dataset size, available computational resources, and the balance between performance and efficiency desired for the application.

The size of the word embedding determines the dimensionality of the vector space in which the words are represented. For example, a common choice for BERT is to use 768-dimensional word embeddings for English language models. However, in certain scenarios, a smaller embedding size like 128 or 256 dimensions may be used to reduce memory requirements or computational complexity. A “small embedding” refers to a lower-dimensional vector representation compared to larger embeddings.

A “large embedding” in the context of language models like BERT typically refers to a higher-dimensional representation of words or tokens in the input text. These higher-dimensional embeddings allow for more expressive representations, capturing fine-grained semantic details and nuanced relationships between words. Having larger embeddings entail increased memory requirements and computational complexity but also enhance the model's ability to understand complex language patterns and improve its performance on various natural language processing tasks, such as by way of example, question-answering, sentiment analysis, or language translation.

The embedding layer in FIG. 2 is responsible for converting input tokens into dense vector representations. Specifically, the input text can be first tokenized, which involves splitting it into individual words or subword units called tokens. Tokens can represent complete words or smaller units like word fragments or subword units (e.g., “playing” split into “play” and “##ing”). Each token is then mapped to a unique index based on a predefined vocabulary. This mapping assigns a numerical representation to each token, allowing the model to process them computationally. The embedding layer also contains a lookup table or matrix that stores the word embeddings for each token in the vocabulary. Each token's index is used to look up its corresponding word embedding from the embedding matrix.

The embedding layer retrieves the word embeddings for each token and outputs a sequence of dense vectors. These vectors serve as the initial representations of the tokens and capture their contextual information. The word embeddings obtained from the embedding layer are typically fixed during the training of the BERT model, as they have already been pre-trained on a large corpus of text data. However, during fine-tuning, additional layers of the BERT model can be trained to adapt the embeddings to a specific downstream task.

In effect, the embedding layer is a component in BERT and other transformer-based models, that converts raw textual, image, sequence, or other input into meaningful numerical representations that can be processed by the subsequent layers of the model. The word embeddings serve as the input to the encoder layers (also referred to herein as the ‘encoder stack’) in BERT, where the model further processes and refines the representations to capture contextual information from both left and right contexts of the tokens.

The encoder stack is another component of a general transformer or BERT model. The encoder stack can include multiple stacked encoder layers to process the input tokens and capture the contextual representations. Each encoder layer in the stack can be composed of a multi-head self-attention mechanism and a feed-forward neural network. The typical encoder stack operates by first converting input tokens into word embeddings using the embedding layer. This part of the process may be performed on the host computer or alternatively or in addition formed on a TSP. The word embeddings serve as the initial representations of the tokens and contain semantic information. Then the encoder stack utilizes a self-attention component that allows each token in the input sequence to attend to other tokens. Self-attention calculates attention weights for each token based on its relationships with other tokens. The attention component helps the model to understand any dependencies and the relationships between different words in the input sequence. The self-attention component in each encoder layer is typically multi-head, meaning it operates with multiple parallel attention sub-layers. Each sub-layer learns different relationships and captures different aspects of the input tokens. The outputs of these multiple attention heads are then concatenated and transformed to obtain a combined representation.

After the multi-head attention sub-layer, the output can be passed through a feed-forward neural network (FFN). The FFN consists of two linear transformations separated by a non-linear activation function, such as the ReLU (Rectified Linear Unit). This network helps capture complex patterns and relationships in the input sequence.

To facilitate training and alleviate the vanishing gradient problem, layer normalization and residual connections are applied. Layer normalization normalizes the output of each sub-layer, reducing the impact of input variations. Residual connections allow the model to retain information from earlier layers by adding the original input to the output of each sub-layer.

The process of passing the input sequence through the multiple layers of the encoder stack helps refine the contextual representations of the tokens. The lower layers capture more local information, while the higher layers capture broader contextual information.

By stacking multiple encoder layers together, BERT can effectively model the bidirectional relationships between tokens and capture a comprehensive understanding of the input sequence. This enables the model to perform a wide range of downstream natural language processing tasks, such as question-answering, text classification, named entity recognition, and more.

A pre-trained BERT model can be fine-tuned to target specific tasks (e.g., Question Answering) by changing the output layer to match the down-stream tasks during a fine-tuning step. The encoder stack is built from N identical layers (where N is a model hyper-parameter); each layer has a multi-headed self-attention block and a feed-forward block as noted above.

In some embodiments, computations for the self-attention module include the following:

$${Q}_{i} = {XW}_{i}^{q} + {b}_{i}^{q} . \qquad ( 1 )$$

$${K}_{i} = {XW}_{i}^{k} + {b}_{i}^{k} \qquad ( 2 )$$

$${V}_{i} = {XW}_{i}^{v} + {b}_{i}^{v} \qquad ( 3 )$$

$${head}^{i} = softmax ( \frac{{Q}_{i} {K}_{i}^{T}}{\sqrt{dk}} ) {V}_{i} \qquad ( 4 )$$

$$Sa = {LN}^{*} ( Concat ( {head}_{1} , … , {head}_{h} ) {W}^{0} + {b}^{0} + X ) \qquad ( 5 )$$

where X and

$${Sa}_{i}$$

are

$${the}_{i}$$

the input and output of the self-attention block, respectively. W* and b* are the model weights and biases, while h and dk are hyper-parameters representing the number of heads and the head size, respectively. The output of the self-attention block is passed to a feed-forward layer that performs the following:

layer_out=LN(GELU(SaW¹+b¹)W²+b²+Sa) (6)

where GELU is a Gaussian Error Linear Unit. The output (layer out) of a layer feeds the next layer in the encoder stack, and the embedding layer feeds the first encoder layer.

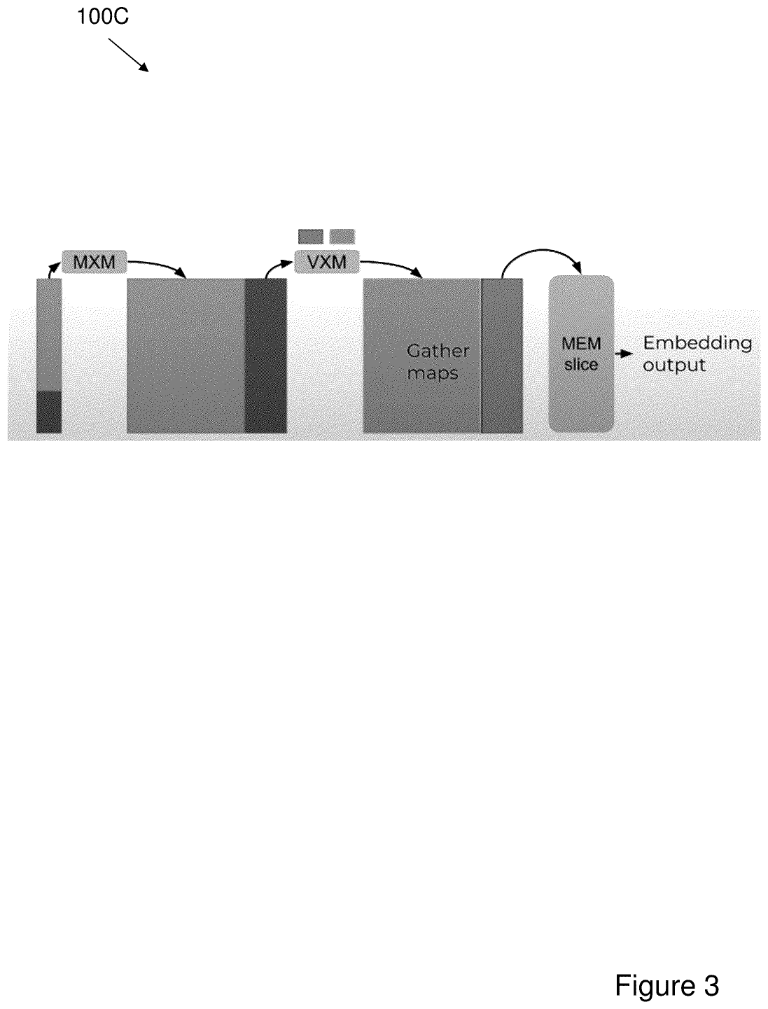

FIG. 3 illustrates a computing system supporting small embeddings 100C into a BERT transformer model on a TSP such as disclosed herein. In this embodiment, memory addressing can involve a gather operation with a map corresponding to a desired entry. Since a small embedding has few entries needing lookup, it can generally allow for all entries to be fit onto the same processing slice. In contrast, a large embedding has too many entries to fit into one slice. Multiple N gathers need to be performed for every vector requiring look-up, and gather maps are needed for entries in different slices. In some embodiments, the large embedding can be transformed into a memcopy program and embedded as a sparse matrix.

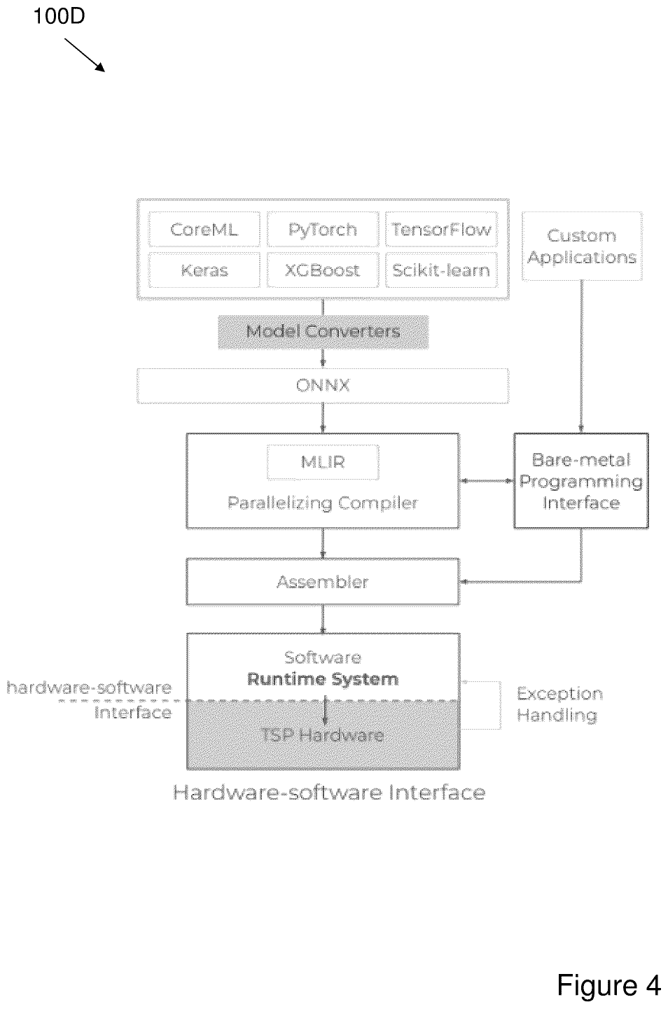

FIG. 4 illustrates a computing system 100D supporting software scheduled deterministic processing of a transformer model on a TSP. In one embodiment, high level models from TensorFlow, PyTorch, or others can be passed through model converters into ONNX or other formats built to represent machine learning models. Advantageously, ONNX defines a common set of operators—the building blocks of machine learning and deep learning models—and a common file format. This data is provided to MLIR (Multi-Level Intermediate Representation) and a parallelizing compiler system that can provide front-end optimizations, perform layout markings and optimizations such as taking multidimensional tensors and mapping them down to a physical address space which is relatively simple and one dimensional and has no hierarchy. In addition, re-writes are supported, taking higher level neural network graphs and decomposing them into semantically equivalent graphs amenable to operations that exist in the TSP ISA. Vector-level scheduling, translation into assembly, and implementation for runtime control of the TSP enable software to allow for scheduled deterministic processing of the model or other data processing task.

Deterministic processing is enabled by hardware control of a chip, card, computer, rack, or network level using the previously described compiler. The chip can have integrated software control units at strategic points to optimize data movement and processing and be organized in a way consistent with typical data flow found in machine learning models. Advantageously, a deterministic processor with a stream programming model enables precise reasoning and control of hardware components to achieve good performance and power efficiency. The TSP guarantees determinism by eliminating all reactive elements in the hardware, for example, arbiters and caches. The instruction ordering is entirely software controlled and the underlying hardware cannot reorder these events—they must complete in a fixed amount of time. This has several consequences for system design, enabling zero variance latency, low latency, high throughput, and minimal latency at batch size 1. This allows running a batch size of 1 computation on a single text corpus, image, or other data structure during inference processing with real-time responsiveness in applications.

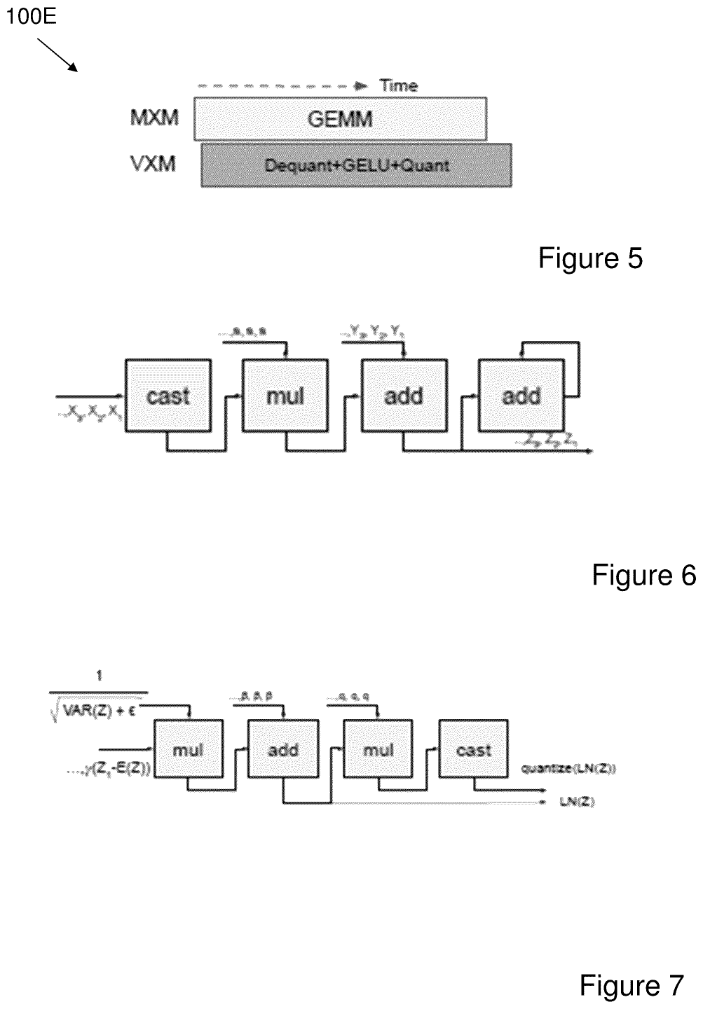

FIGS. 5-15 illustrate in more detail the operation of the BERT transformer model on a TSP which has modules for matrix and vector multiplication (MXM, VXM). To reduce latency attributable to various non-linear components inherent in many large language models, such as softmax, layernorm and GELU, the chaining capability of the VXM to pipeline the nonlinear computations with matrix multiplications can help maximize utilization of the MXM units on the TSP. For example, the input to the non-linear GELU function is the output of a general matrix multiply (GEMM) in the form of AW+b as shown in eq. (6). GEMMs can be directly mapped to the MXM and the associated accumulator. Since each MXM plane has 320×320 MACCs, if W is larger than that, the multiplication will involve multiple passes (loading weights and then streaming activation). After computing the GEMM, GELU can be computed, which can be approximated as follows:

$$GELU ( x ) = 0.5 x ( 1 + tan h ( \sqrt{\frac{2}{π}} ( x + 0.044715 {x}^{3} ) ) ) \qquad ( 7 )$$

GELU can be mapped onto the VXM by building a pipelined chain of 13 ALUs in one embodiment. This pipelined chain produces a new result vector every clock cycle. The int32 GEMM result needs to be dequantized to fp32 before calculating GELU, and the output of GELU needs to be quantized back to int8 before being consumed by downstream GEMMs. The remaining 3 ALUs of the VXM can be used to pipeline the dequantization and quantization stages with GELU. Since downstream GEMMs have to be scheduled after GELU starts generating results, GELU is scheduled to execute after the upstream GEMM has finished computing, the MXM can be kept idle for the execution time of GELU. Since the input to GELU is the largest activation tensor in BERT, and with a throughput of one result vector per clock cycle the execution time of GELU is equal to or larger than that of the GEMM feeding it. To reduce the MXM idle time, the GEMM is pipelined with GELU such that every output vector from the GEMM is directly sent to the VXM to start computing GELU.

As shown in FIG. 5 with this pipelining approach, most of GELU's latency is hidden behind the GEMM execution.

As seen in equations (5) and (6), the self-attention and feedforward blocks perform layer normalization (LN). Both LN operations have the form LN(dequantize(X)+Y) where X is the int32 output tensor of a GEMM and Y is the fp32 output tensor of a previous LN. Layer normalization is calculated as follows:

$$LN ( Z ) \frac{Z - E ( Z )}{\sqrt{VAR ( Z ) + ϵ}} γ + β \qquad ( 8 )$$

where E(Z) and VAR(Z) am the mean and variance of tensor Z along the inner dimension, respectively. If Z has the shape of (k, j), then E(Z) and VAR(Z) will have the shape of (k, 1), which will be broadcast back to (k,j) when performing point-wise operations with Z, γ and β are learnable parameters and ∈ is a small value to avoid any potential division| zero. Performing layer normalization requires three sequential passes over the input tensor Z: one pass to calculate E(Z), a pass to calculate VAR(Z), and a final pass to normalize Z. We leverage all 16 ALUs of the VXM to accelerate these passes.

1) First Pass: To start the LN, Z must be computed, and so producing Z is overlapped with calculating E(Z). As shown in FIG. 6, a chain of three ALUs is built that dequantizes X (cast and a multiplication by a constant) and adds the result to Y to calculate Z. This chain generates a vector of Z (Zᵢ) every cycle, where Z; represents the ith column of the tensor. Z is transmitted from the VXM to memory and also directly sent to another ALU to sum all the vectors of Z. Since this chain only needs four ALUs, four parallel chains are built to generate four vectors of Z every cycle. After producing all vectors of Z, the average of Z is calculated by adding the partial sums (from the parallel chains) and dividing the result by the number of vectors in Z. The outputs of the first pass are Z and E(Z).

Second Pass: After calculating the mean, the variance can be computed as follows:

VAR(Z)=E((Z−EZ))²) (9)

Since Z and E(Z) have been computed, eq. (9) can be mapped to a chain of three ALUs as shown by the light grey ALUs in FIG. 6. The ALU first performs the subtraction. Second, the ALU squares the difference, and third, the ALU then accumulates the incoming vectors. The termZ-E(Z) is needed in eq. (8) and eq. (9), to store that result from the second pass and reuse it later. However, to reduce the number of ALUs used in the third pass, another ALU can be added to calculate 7(Z-E(Z)). As shown in FIG. 7, this multiplication is performed by the first multiplier and then fed to the adder.

Dark gray colored ALU and is written to memory. Similarly to the first pass, the 4-ALU chain in the second pass also produces one output vector every cycle, and four parallel chains are created to increase the concurrency to four vectors per cycle. At the end of the second pass, c is added to VAR(Z) and the reciprocal square root of the result calculated. The outputs of the second pass are the numerator and denominator of the first term in eq. (8).

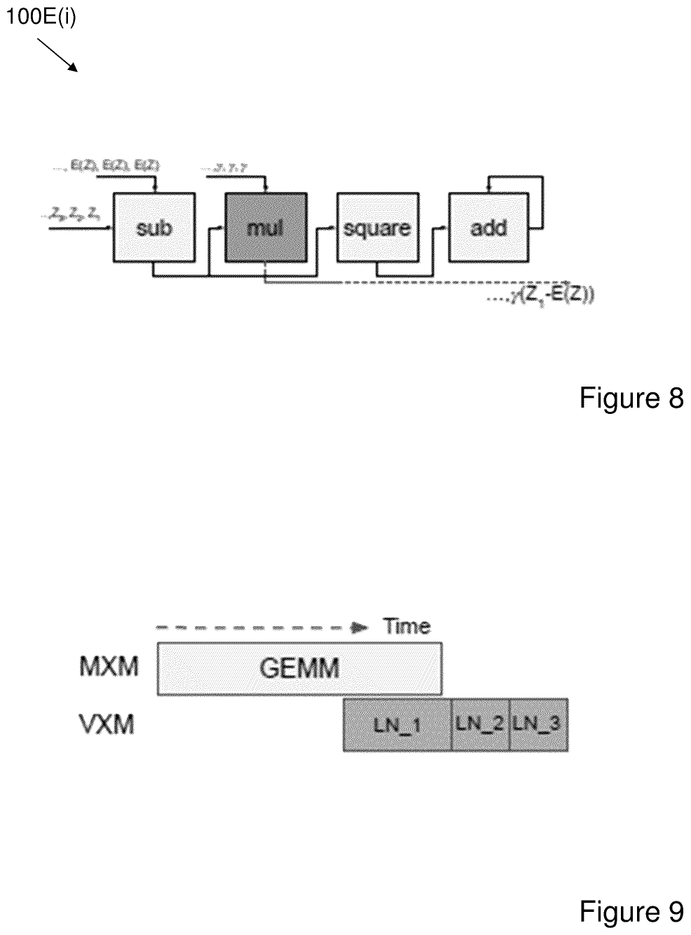

3) Third Pass: In an int8 quantized BERT, the output of the layer normalization is consumed twice: it gets multiplied by a weight matrix in a downstream GEMM, and it gets added to another tensor just before being consumed by another layer normalization block. In the final pass of LN, both an int8 and fp32 output can be calculated. Similarly to the previous two passes, a chain of four ALUs can be used. As shown in FIG. 8 the first ALU calculates the product of the outputs generated in the second pass and the second ALU adds p to the result.

The output of the second ALU is the fp32 results of the layer normalization block (LN(Z)). This output is quantized as it is produced to also generate the int8 quantized tensor which will be sent to the downstream GEMM. Four parallel chains can be used in this pass. With this LN implementation, all 16 ALUs of the VXM can be fully utilized during the entire execution time. Since the mean can be calculated while producing Z and Z-E(Z) reused from the second pass, Z needs to be read from memory only once throughout the three LN passes. Assuming the shape of Z is (k, j), the number of cycles needed for the layer normalization is:

$$LN\_cycles = 3 * j * ⌈ \frac{k}{320} ⌉ * \frac{1}{4} + c \qquad ( 10 )$$

In each of the three passes, a throughput of 4 physical vectors is available per cycle. The number of physical vectors depends on how many rows (j) are in Z and how many physical vectors compose a single column (each physical vector can hold a maximum of 320 elements if a single TSP is used to execute the model). After the first and second passes, a normalization step is performed, in one embodiment, that requires a constant number of cycles (c), which does not change with the size of Z.

As a final optimization, the first LN pass is executed while the GEMM producing X (one of the inputs to LN) is executing. As shown in FIG. 9, this optimization effectively hides the latency of the first LN pass completely. With this optimization, the MXM unit will only be idle for the time needed to finish the second and third LN passes.

C. Self-Attention Block

Within the self-attention block, equations (1) to (4) must be performed for every head in the model where the number of heads (h) is a model parameter. Instead of performing h separate matrix multiplications to compute Qi (eq. (1)), a common transformer optimization is to concatenate the different weights (Wqi) of all the heads and perform one large matrix multiplication that generates Q which includes the Qi of all the heads. In one implementation, Q, K and V are all calculated using this optimization strategy.

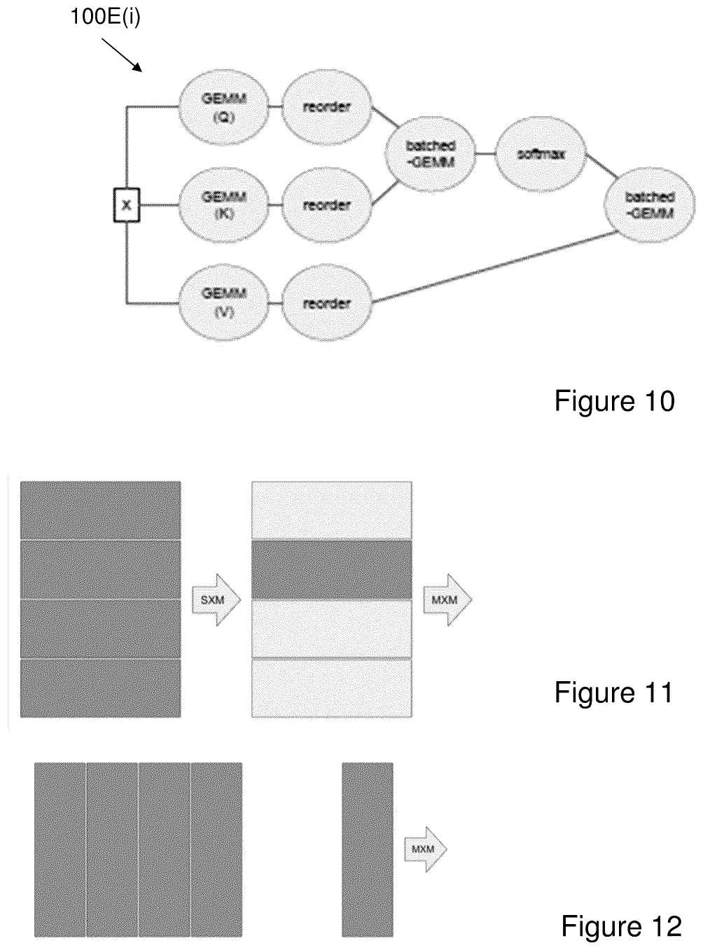

FIG. 10 shows the compute graph of the self-attention block. It includes nodes (reorder) representing the reshape and transposition operations needed to separate the different heads from the concatenated Q, K and V. A thick line between two nodes represents a change in data type performed as a quantization or a dequantization step. As mentioned earlier, the output of the GEMM is int32 on the TSP, but the inputs are expected to be int8, and the inputs and outputs of the softmax are in fp32. The batched-GEMM represents several independent GEMMs (one for each head) to perform the GEMMs in eq. (4) for all the heads in the model.

Execution of GEMMs can be parallelized across all MXM planes. When a GEMM requires multiple MXM passes (for example, when the weights tensor has more than 320 rows or columns) on the same MXM plane, delay of installing weights is hidden by loading the weights of pass i while executing pass i−1, so there are no idle MXM cycles between passes; that is, each MXM plane is continuously producing data.

Refer now to FIGS. 11 and 12. Performing transpositions to separate the different attention heads can be an expensive operation. Since the output of these transpositions are only used as inputs to the batched-GEMM, this step can be simplified to avoid transpositions and just rely on reshaping and masking the inputs being sent to the MXM. The SXM masks the streaming data so that only the proper data is sent to the MXM as a tensor streams through the SXM toward the MXM. The SXM masks out non-relevant information because the MXM does a vertical accumulation and any unrelated result would result in a conflict if the chip were to perform the matrix multiplication within the orientation of the streaming data rather than transposing the data to fit the orientation of the MXM. With this simplification, the reorder operation is performed on-the-fly in the SXM as data is traveling from memory to the MXM.

One non-linear component in the self-attention block is the softmax operation. Similar to layer normalization, softmax requires more than one pass on the input tensor with h-independent softmax operations (one for each head) performed. Softmax is optimized in a similar approach to the one used in optimizing the layer normalization with intermediate values stored from one pass that are reused in another pass, and four parallel chains of ALUs built that allow production of four vectors of results during every softmax pass.

The softmax function is a mathematical function commonly used in machine learning and deep learning to convert a vector of real numbers into a probability distribution. It takes as input a vector of arbitrary real-valued scores and transforms them into values between 0 and 1 that sum up to 1. The softmax function is defined as follows:

Given an input vector x=[x₁, x₂, . . . , xn], the softmax function computes the output vector y=[y₁, y₂, . . . , yn] where:

yᵢ=exp(xᵢ)/(exp(x₁)+exp(x₂)+ . . . +exp(xn)) for all i=1,2, . . . ,n

The softmax function is often used in multi-class classification tasks, where the goal is to assign an input instance to one of several possible classes. The output of the softmax function can be interpreted as the probability distribution over the classes. The class with the highest probability is typically chosen as the predicted class.

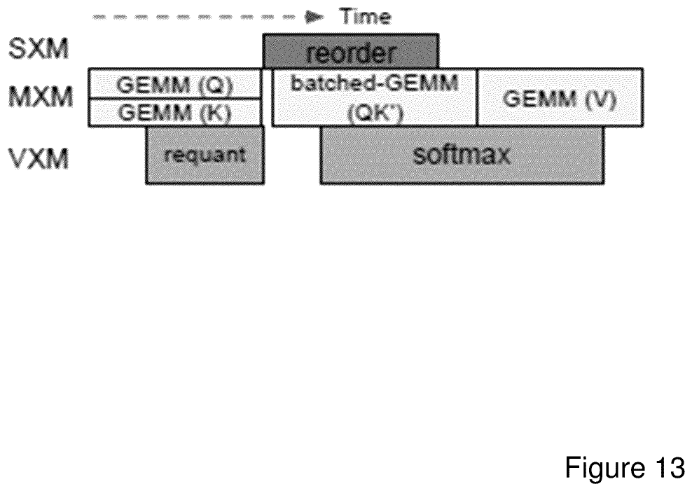

FIG. 13 shows the scheduling of softmax and reorder operations with the other GEMMs in the self-attention block. By pipelining the reorder operation with the execution of the batched-GEMM, the batched-GEMM is started without waiting for the reorder operation to finish execution. The latency of the softmax operation can be hidden completely by starting its execution as soon as the first vector of results is produced from the batched-GEMM operation and overlapping the last part of the softmax operation with another independent GEMM (calculating V does not have a dependency on the result of softmax). Note that during the batched-GEMM shown in FIG. 13, a pipeline starts by reading a vector from MEM, reordering it on the SXM, passing it to the MXM, then sending the MXM result to the VXM to flow through several ALUs (softmax pass) to be finally written to MEM again.

A key advantage of the foregoing described implementation on the TSP is that it not only provides low latency, but that it also provides low tail latency. Since the TSP is deterministic, there is full control in scheduling instructions and the implementation does not suffer from variation in latency due to hardware-managed scheduling or non-uniform memory access latency. Having full control over scheduling every instruction allows hiding the latency attributable to all non-GEMM components. The key optimizations that enabled low latency on batch-1 inferences are:
1) Deeply pipelining non-GEMM operations with GEMMs to hide their latency and increase the utilization of the MXM.
2) Optimizing the layer normalization operation to reduce the idle time during which the MXM is waiting for LN results.

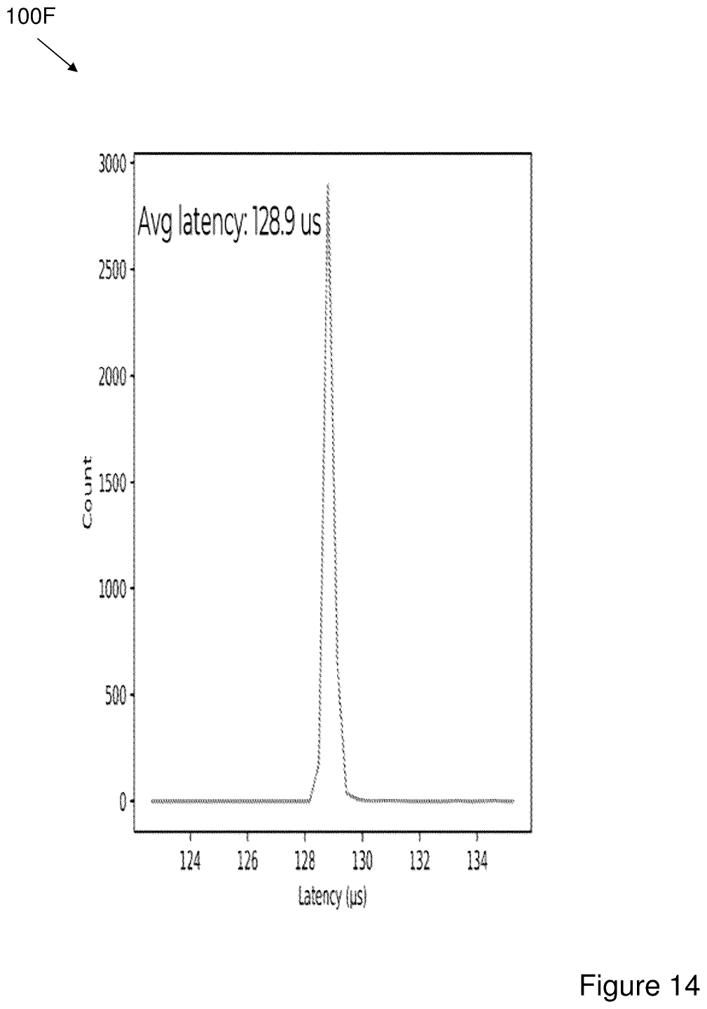

This deep pipelining also reduces the on-chip scratchpad memory needed for intermediate results, which leaves more on-chip memory to be used for constant data. In effect, as seen with respect to FIG. 14 average latency is reduced to substantially less than 200 microseconds, and in some embodiments can support an average latency of about 130 microseconds. The actual results of latency is based on thousands of inferences (e.g., 4,000 inferences) for a large language model (LLM) like BERT Large, ChatGPT or Meta's LLAMa. This is an end to end latency that includes the time to move data from the host to the TSP plus the time needed to finish the TSP computation and then return the result back to the host. There are two basically two parts of the inference that are not accounted for in this latency for comparison with the methodology used by NVIDIA when they measure the latency for their A100 GPU based inference system.

The inference starts with the input string (e.g., text or audio or graphics) and the host performs the tokenization. The tokens are sent to the TSP and after the inference, the final projection including converting back to strings is generated. Moving from streaming to tokens and back or from talking to strings are not included in here and again this is the same methodology used in tokenizing video. In one embodiment the tokenization may be done on the TSP but there is only a small benefit because that process is not compute heavy and it is possible to adjust the pipeline on the host to hide the latency of this tokenization.

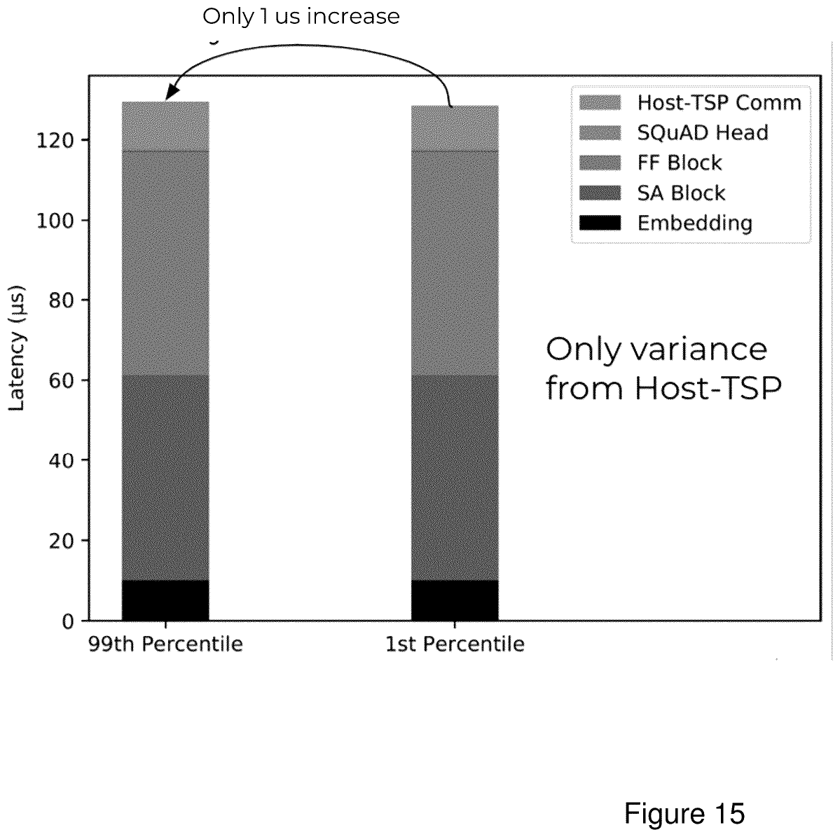

Referring now to FIG. 15, the source of the latency is illustrated for a LLM model executed on a TSP. The sources of the latencies are shown divided bottom to top into 1) embedding; 2) self attention; 3) compute for feedforward block; 4) SQuAD Head; 5) host to the TSP latency.

While latencies associated with factors 1-3 above are common to many transformer models, the SQuAD Head is a specific component or layer that is added on top of the base BERT model to fine-tune it for a specific task called the Stanford Question Answering Dataset (SQuAD)). This additional layer is designed to predict the start and end positions of the answer within the given context for a given question. The SQuAD Head is typically implemented as a couple of feed-forward layers followed by a softmax activation.

The host to the TSP communication latency is measured by comparing the 1st and the 99th percentile to confirm that the latency variation comes from Host to TSP communication because that link is not deterministic and every time this boundary is crossed (from deterministic to non-deterministic) there is the potential random variation that is sampled showing about a one microsecond variation in this example. Absent this boundary between the deterministic TSP accelerator and the host processor, latency is a known value regardless of the number of times the model is executed with virtually no tail latency.

Another feature of TSP processing of the transformer model using the method described herein involves low tail latency, which can be defined as a latency or delay experienced by the slowest individual requests or operations in a system or application. It represents the time taken by the outliers, or the worst-case response times, rather than the average or typical response times. While the average latency may provide a general understanding of system performance, tail latency focuses on the extreme cases where certain requests experience significantly higher delays.

Tail latency is particularly important in real-time and latency-sensitive applications where even a small number of slow requests can negatively impact user experience. Monitoring and analyzing tail latency is essential to understand the performance characteristics of a system comprehensively. By substantially eliminating tail latency to under 200 microseconds, the described system improves overall performance, reliability, and user satisfaction compared to the GPU platforms. For example, as seen in FIG. 15, 1st and 99th percentile tail latency can be compared, with only a 1 microsecond differentiation.

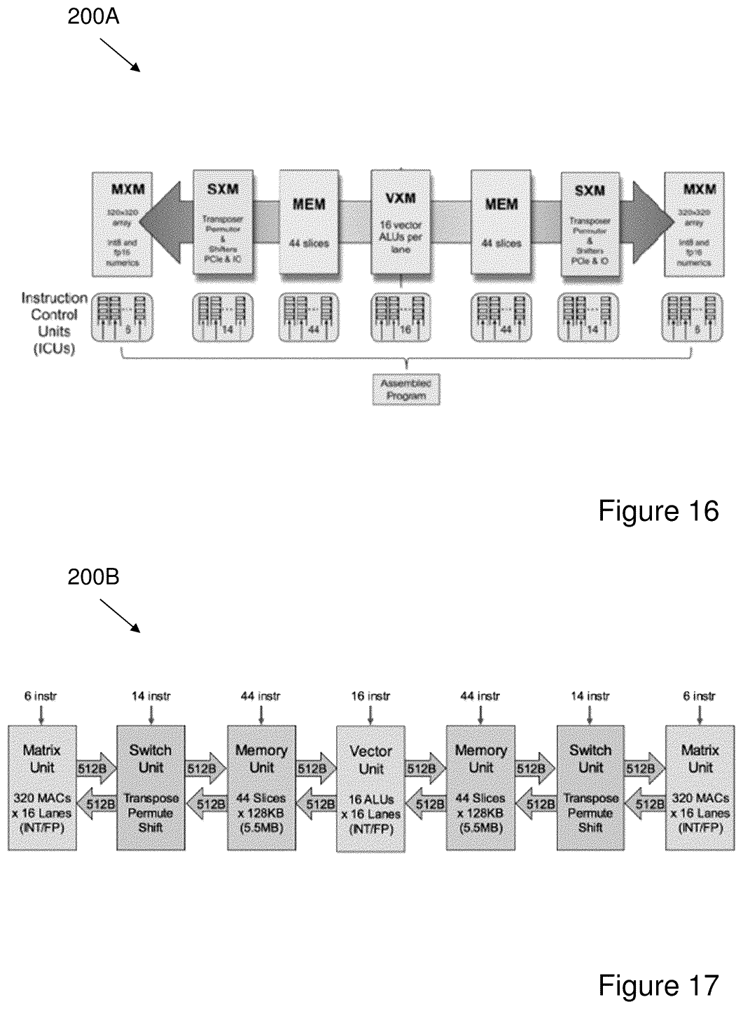

FIG. 16 depicts one embodiment of a system 200A with a Superlane of a TSP comprising multiple tiles. These tiles include modules for matrix and vector multiplication (MXM, VXM), data path switching between tiles (SXM), and memory storage and retrieval (MEM). Each tile (and all tiles in a slice) receives instructions from the ICUs, the instructions in the ICUs being the result of hand-coding or the output of a compiler that are transferred to the TSP. This architecture decouples flows of data from flows of instructions in the TSP. Each lane in a tile of a Superlane processes one byte.

FIG. 17 depicts one embodiment for data flow in a Superlane. Data between two adjacent tiles, such as in the MXM or the SXM, flows bidirectionally, though typically moves along one direction in a Superlane, and data is transferred on every clock cycle. When the processing of data is complete in one Superlane, the data is either returned to the host computer or transferred by tiles in the SXM to another Superlane for additional processing.

A Superlane processes streams of data in a selected number of lanes (e.g., 16 lanes). Each instruction is performed on all lanes at once, and then, if required by the instructions being executed, in the next Superlane in a subsequent cycle, and so forth. Thus, over 20 cycles, each instruction can execute on all 320 lanes across the 20 Superlanes. Because the architecture lacks register files, the compiler must schedule the streaming data to be available to the functional module at the designated time to execute the designated instruction.

FIG. 18 depicts one embodiment with multiple Superlanes partitioned into slices of tiles (for example, tile 301A). Each slice (for example, slice 302A) in a TSP performs any of a variety of functions under the control of instructions transferred from buffers in the Instruction Control Unit. These functions include memory storage and retrieval for data in a Superlane (MEM), integer (INT) arithmetic, floating point (FPU) arithmetic, and transferring data between Superlanes (NET or SXM). In some embodiments, each of the slices operates independently and are coordinated using barrier-like synchronization instructions. Element 303A in FIG. 18 depicts a partition, in this case, of one set of matrix multiplication tiles.

For example, the MEM slices perform Read and Write operations but not Add or Mul, which are only performed in VXM and MXM slices. All of the tiles in a slice execute the same set of instructions, so it is possible to locate all of the common instruction decode and dispatch logic into the ICU and partition the normal instruction execution pipeline into two sets of instructions: (i) instruction fetch, decode, and parceling and (ii) operand read, execute, and writeback. Functional tiles can operate without having to receive explicit instructions, or only receiving intermittent or limited instructions, from the ICU when the tiles are dedicated to a specific function, potentially simplifying operation of the processor.

In at least one embodiment, the tiles in the same slice (but not necessarily the same Superlane) execute instructions in a “staggered” fashion where instructions are issued tile-by-tile within the slice over a period of N cycles. For example, the ICU for a given slice may, during a first clock cycle, issue an instruction to a first tile of the slice (e.g., the tile directly connected to the ICU of the slice, as illustrated in FIG. 18), which is passed to subsequent tiles of the slice over subsequent cycles.

In at least one embodiment, each Superlane comprises a first set and second set of matrix multiplication tiles (MXM1 and MXM2), a first and second set of data path switching tiles (SXM1 and SXM2), a first and second set of memory tiles (MEM 1 and MEM2), and a first set of vector calculation tiles (VXM1), wherein just one tile in MXM1 transfers data with one tile in SXM1, wherein just one tile in SXM1 transfers said data with just one tile in MEM1, wherein just one tile in MEM1 transfers said data with just one tile in VXM1, wherein just one tile in VXM1 transfers said data with just one tile in MEM2, wherein just one tile in MEM2 transfers said data with just one tile in SXM2, and wherein just one tile in SXM2 transfers said data with just one tile in MXM2.

In this embodiment, data transfers are entirely in one direction, for example MXM1 to SXM1 to MEM1 to VXM1 to MEM2 to SXM2 to MXM2. In other embodiments, data transfers occur in two directions, for example, one set of data transfers from VXM1 to MEM1 to SXM1 to MXM1, and another set of data transfers from VXM1 to MEM2 to SXM2 to MXM2.

In at least one embodiment, each Superlane, and indeed the entire TSP, executes a single set of instructions, so it may be considered as a single processor core. However, as depicted in FIG. 12, in another embodiment, the TSP Superlanes are partitioned into two sets of functional modules. In the split architecture, the central vector multiplication tile that contains 16 ALUs can allocate the ALUs to either set. In other ECINs, additional slices of VXMs (not shown) may be allocated to a set. The additional VXM slices may be physically or logically located next to one of the MXM slices.

For at least one embodiment, FIG. 5 depicts a system 500 of controlling host computers and a set of TSPs, with multiple communication links. Host CPUs communicate with the TSP using PCIe interfaces based on Ethernet. USB communication links are also used between the host CPUs and the TSPs.

Streams

Machine learning algorithms typically operate on vectors with scalar coefficients of a specified data type (e.g., INT8, FP16, etc.). The Superlanes operate on data representing vectors, sometimes organized into rank-2 tensors, and rely on the compiler to transform higher rank tensors into rank-2 tensors. FIG. 4 depicts a table of instructions that can be performed by the functional tiles that comprise each Superlane. The TSP's programming model is a producer-consumer model where each slice in a partition acts as a consumer and a producer of one or more streams.

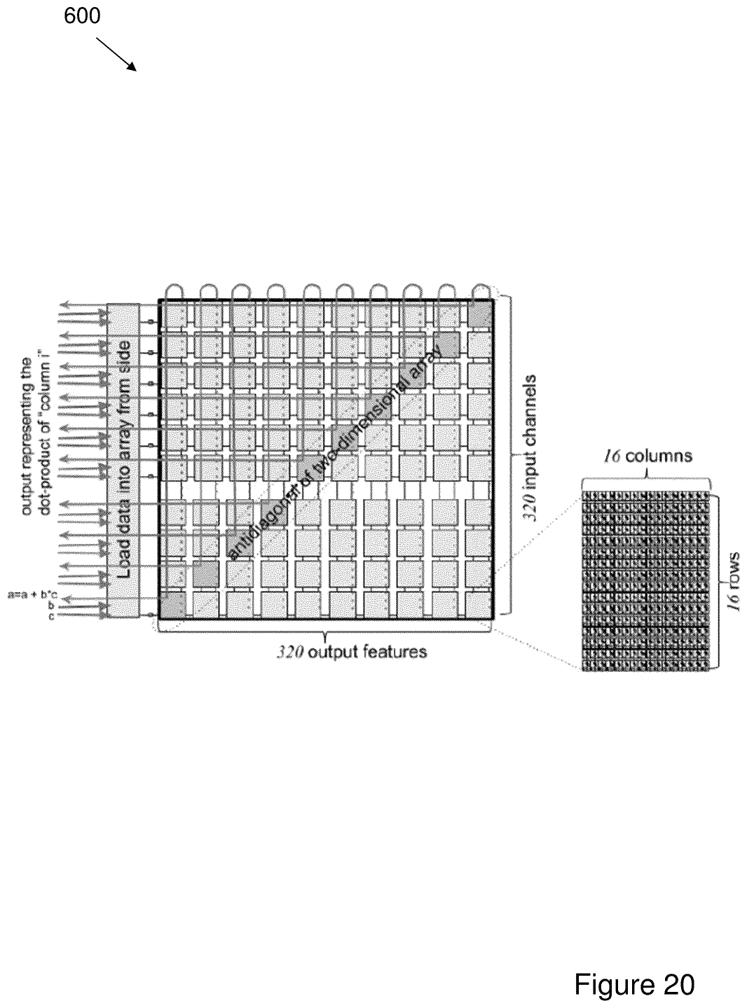

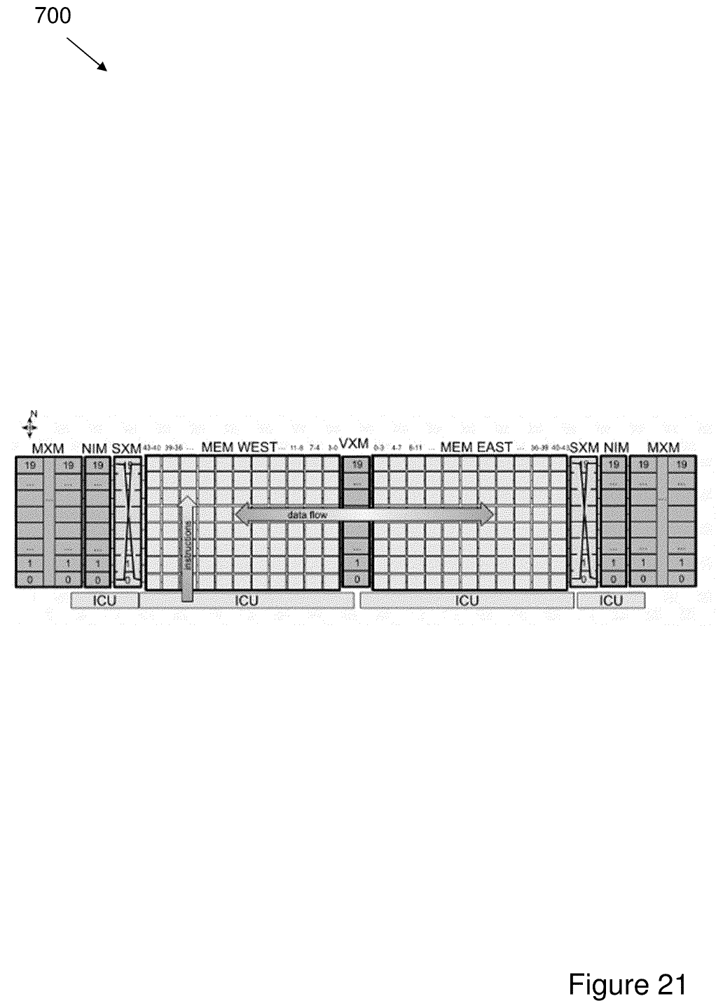

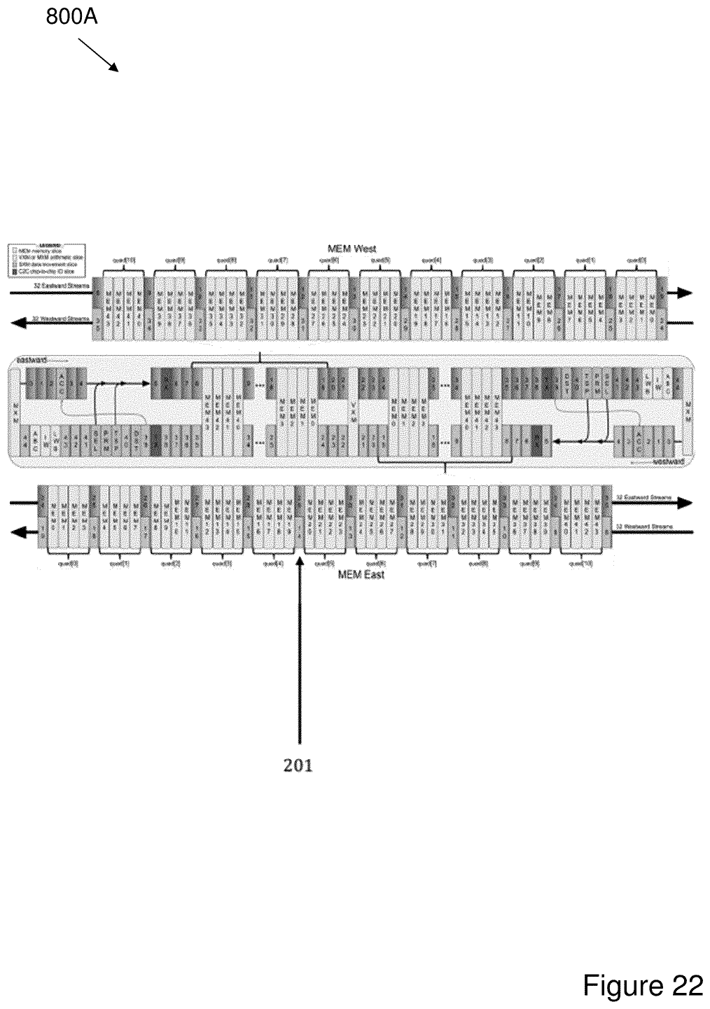

The partitioned architecture 600 and 700 such as illustrated respectively in FIGS. 20 and 21 can support up to 32 streams in each set of tiles in two directions (the number of streams is dependent on the availability of wiring of the inputs and outputs for the stream registers). The stream registers 800A are depicted in FIG. 22 as the integer-numbered grey boxes between the memory slices, such as stream registers 29 and 14 (element 201 in FIG. 22) between memory slices MEM19 and MEM20. Each stream automatically progresses in its designated direction on every cycle, moving 32 bytes. Any inter-lane data movement within a vector uses the SXM slice.

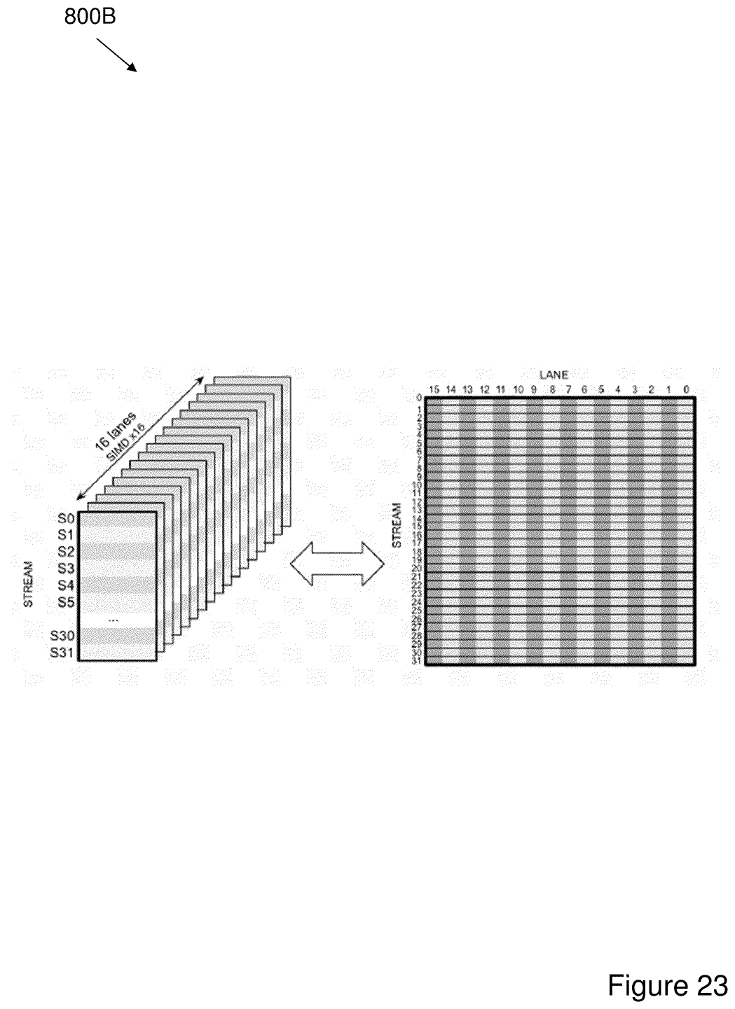

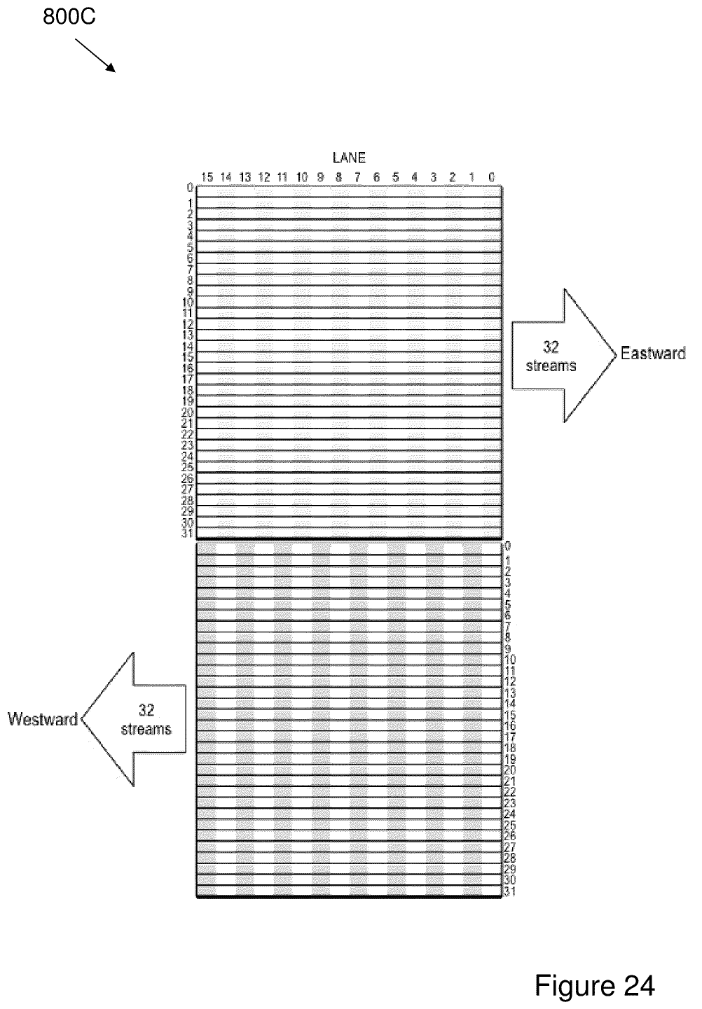

When a set of data representing a vector is read from main memory, it is given a stream identifier (0 . . . 31) 800B and direction of flow 800C in a Superlane (see respectively FIG. 23 and FIG. 24). Once a vector is read into one or more stream registers in a lane (stream registers as depicted, for example, in FIG. 8A), it becomes a stream and flows towards the slice that is processing it, which produces a result stream. As data in a stream flows through a slice, each functional module can intercept the data and perform a calculation (if the module is calculational) or move data between lanes (in the switching modules).

The stream registers are used to transfer operands and results between slices. A common software pattern involves reading operand data from one or more MEM slices that is then subsequently consumed and operated on by a downstream arithmetic slice. The results of the operation are then transferred to another stream such that they can be written back to memory. For example, a Z=X+Y operation might require four instructions: Read S1,X and Read S2,Y are executed on two MEM slices and directed toward an VXM slice to perform the Add S1,S2,S3. Then the result is stored back to memory via a Write S3,Z.

The lane structure is optimized for INT8 data, but larger operands (INT16, INT32, FP16, or FP32) can be formed by combining streams. This approach enables the compiler to operate on 320-element vectors for all data types. Wider data types are assigned to adjacent streams (e.g., S0, S1, S2, S3) along aligned boundaries. For increased reliability, the Superlane applies a 9-bit error-correction code (ECC) across all 16 lanes, correcting nearly all errors. The TSP logs these errors and reports them to the host computer. In one embodiment, the ECC protocol is SECDED (single-error correction with double error detection). Before a functional slice operates on a stream of data, it checks the ECC bits to ensure data integrity before operating on the data.

Each element of a stream is 1-byte, with larger data types (e.g., INT16, INT32, and FP32) constructed from several streams (2, 4, and 4 respectively). Multi-byte data types are always stream-aligned based on the size of the data type. For instance, INT16 is aligned on a stream pair, bi-stream, and INT32 is aligned on a quad-stream (e.g., stream 0, 4, 8, . . . ). Data alignment is accomplished by the compiler or through the API.

Each stream has a “valid/empty” bit precisely tracking the stream's load-to-use time beyond which the stream is considered logically dead and no longer propagated, which achieves a reduction in power consumption of the TSP.

The Instruction Control Unit

Some instructions in the ICUs are common to all functional slices. As such, the instructions contain common instructions like NOP and Repeat, and synchronization instructions Sync and Notify to allow the functional slices to be initially synchronized, so the compiler can accurately determine instruction execution times and allow cooperative parallelism among the functional slices. ICUs retrieve pages of instructions in the MEM partitions, sending Ifetch instructions across side channels in the memory slices, and receiving the instructions from memory back along the same side channel.

The ICUs can provide explicit instruction fetching for the slices with the Ifetch instruction, and inter-slice synchronization using the Sync and Notify instructions to perform a chip-wide barrier synchronization among participating functional slices. A repeated-NOP (no-op) instruction allows for precise cycle-by-cycle control of inter-instruction delay. For example, the compiler has cycle-accurate control when scheduling two operations A and B using an intervening NOP so that N clock cycles separate the operations A and B, e.g., Operation A then NOP(N) then Operation B.

The compiler uses explicit NOPs to provide temporal separation between two instructions in the program order. A NOP has a repeat count 16-bit field which allows one NOP to wait between 1 ns and 65 μs for a 1 GHz clock frequency. The compiler uses NOP instructions to control relative timing of the functional slices and data on which the functional slices operate. The repeated NOP is implemented in the ICU's tile and is common to all functional slices. While the NOP instruction can be the most common instruction, the NOP instruction is not typically included in the specification for a machine learning model, but rather is inserted into the instructions generated from the model by the compiler.

The Vector Processing Tiles

The central vector unit VXM contains 16 Arithmetic Logic Units (ALU) per lane. Each ALU can perform a 32-bit calculation using aligned groups of four stream bytes as operands. In addition to the usual arithmetic and logical operations, these ALUs can convert between integer and floating-point formats. The VXM also performs common normalization functions such as ReLU and the hyperbolic tangent (tanh) as well as exponentiation and reciprocal square roots, allowing programmers to build their own normalization functions.

In at least one embodiment, each Superlane implements a 4×4 mesh of vector ALUs using the 16 vector ALUs per lane (in this example configuration). Each of the ALU's 32-bit input operands are organized along an aligned quad-stream group.

The vector ALUs do not produce condition codes or status flags from the last instruction; they are stateless. Instead, the VXM provides both saturating and modulo variants (add_sat, add_mod and mul_sat, mul_mod) for addition and multiplication, which allows differing semantics for handling arithmetic exceptions. The TSP supports chaining together two or more vector ALUs within each lane, allowing multiple ALU operations to be performed without transferring the intermediate results to main memory, saving a write and subsequent read of each intermediate result. This allows for efficient parallel implementations of algorithms for batch normalization, quantization, or more complex activation functions like the leaky ReLU activation function, for example.

The Matrix Processing Tiles

Architecture and data flow of an MXM multiplication tile for at least one embodiment can involve a matrix execution module (MXM) that comprises four independent 320-by-320 grids of multiply-accumulate (MACC) modules. Each 320 by 320 grid comprises 20 16 by 16 sub-grids that produce a partial-sum/dot product result each cycle and pass the result to an adjacent tile for use in its computations. It uses 16 streams each with 16 bytes to install 256 8-bit weights (IW) in each gird on every cycle. Using all 32 streams in each direction allows weights to be placed simultaneously in both MXM partitions, loading all 409,600 weights on-chip in less than 40 cycles. With weights installed, every cycle the MXM can generate a new INT32 dot-product of input activations with installed weights. The features output from the MXM can be accumulated using the accumulators on each INT32 or FP32 output stream.

The MXM supports calculations for both 8-bit integer (INT8), and 16-bit floating point (FP16), by using two 320×320 byte-planes in tandem for the 16-bit floating point results. The 320-element sum is produced for each output with only a single rounding step at the end to convert to INT32 or FP32 results. MXM processing includes the following operations (instructions): LW—load weights from data flows (streams) to weight buffer; IW—install weights from data flows (streams) or LW buffer into the 320×320 array; ABC—activation buffer control to initiate and coordinate arriving activations; ACC—accumulate either INT32 or FP32 result from MXM.

Each MACC unit has two 8-bit weight registers and two 32-bit accumulators. On each cycle, each MACC unit multiplies the stored weight values by a pair of activation values from the streaming data. Each 16×16 sub-grid can compute an integer partial sum in one cycle and a complete 320-element fused dot-product in 20 cycles. The MAC unit can instead operate as a single FP16 MACC, but these operations require two cycles, reducing throughput by 75% relative to INT8 operations. Each MXM partition has 320×320 MACC units producing 409,600 INT8 operations or 102,400 FP16 operations per cycle. Using all 32 streams in each direction, the TSP can load all 409,600 weight registers in less than 40 cycles.

The Switching Processing Tiles

The switch units (referred to as ‘SXM’ or ‘NET’) execute functions for the transposition, permutation, shifting and rotation of data elements. Collectively, these operations are used for performing tensor reshape operations common to machine learning algorithms. For example, the SXM can rotate or transpose a stream of data across the lanes. The switch unit can duplicate bytes to fill a vector or zero any of the vector elements to pad values. The switch units are the only tiles that communicate between Superlanes. Detailed enablements of the SXM switch tiles are disclosed in U.S. Pat. No. 10,754,621, incorporated herein by reference.

Data movement on-chip is carried out by routing data along pathways: where data is transferred between SRAM and functional modules within each Superlane, and where the SXM transfers data across lanes using two sets of lane shifters. The lane-shifters are usually allocated in pairs since typically a vector is shifted between a lane and its two adjacent lanes in a Superlane. In addition, the SXM provides a permute instruction that uses a programmed bijection to remap the 320 lanes onto a set of similarly indexed streams, one per Superlane.

The distributor slice within the SXM can be used to arbitrarily remap the 16 lanes within each Superlane. As streams pass through the SXM's distributor, they can be remapped at full bandwidth, or zero-fill any or all of the 16 elements. This provides an efficient mechanism for common tensor operations like zero padding or rearranging elements of a 4×4 filter.

A very common operation on tensor data types is transposition. The TSP supports a two-dimension transpose of 256 elements organized as 16 streams each with 16 elements. A transpose operation takes 16 incoming streams and produces 16 output streams with the rows and columns exchanged. This allows the efficient movement of data from the atomic 16-byte MEM word into 16 different MEM slices where they are now addressable. There are two instances of the SXM on-chip, one in each hemisphere (FIG. 5). Each can issue two (2) transpose instructions, yielding a maximum of four (4) simultaneous transpose 16×16 operations. The Memory Storage Tiles

In at least one embodiment, each memory partitions (MEM) has 44 slices of ECC-protected SRAM, with each slice comprising 20 tiles that provide a total capacity of 2.5 MiBytes (a Mibyte is 1048576 bytes) per slice, giving the two MEM partitions a total capacity of 220 MiBytes. Each slice includes at least two sets of memory cells referred to as ‘banks’. Each MEM slice contains pseudo-dual-port SRAMs that can service a pair of read and write requests simultaneously, assuming they are not targeting the same bank. The 88 slices, each with 2 banks, enables up to 176-way memory concurrency to read operands to or store results from streams. Banks of memory not being used can have their power reduced to reduce energy usage.

The 88 slices provide the needed memory concurrency to supply 32 operands per lane, every cycle. Slices of memory are partitioned into 16-word bytes, each word distributed across a Superlane, and each byte of each word processed by one lane of the Superlane. The memory unit can perform two 16-byte reads and two 16-byte writes per cycle, as long as they access different banks, allowing it to both source and sink data in two directions across all lanes in a Superlane.

The on-chip memory supplies operands for each functional slice by reading an address from a memory (MEM) slice, denoted MEM1. In some embodiments, slices in each memory are numbered 0 to 43, with MEM0 closest to the VXM and MEM43 nearest to the SXM.

The memory partitions enable the programming abstraction of a partitioned global shared address space with the address space laid out uniformly across the slices. Each MEM slice supports both direct and stream-indirect addressing modes. Read and Write operations use direct addressing, since the address is fully specified in the instruction itself. Indirect addressing uses the contents of a stream, s, to specify an address map for a Gather or Scatter. With indirect addressing, the physical address comes from the stream value, providing a layer of indirection in the memory referencing.

Each MEM slice has two dedicated dispatch paths, one for each port of the pseudo-dual-ported SRAM. Each memory instruction undergoes an additional address generation stage for strided references by computing the address ai from the previous address ai-1 and strides so that ai=ai−1+s between locations. Strided memory references are accomplished using a sequence of countdown, step, and iters MEM instructions. In the following example assembly-language snippet, it explicitly scheduled the read and write instructions at program time t=10 to iterate starting at address 0×1000, striding by 24 on each iteration, for 112 total vectors, as shown in the example below for MEM West slice 43.

```
.MEM West 43
.read
10: read 0x1000, S_0_e
  step 24
  iters 111
.write
10: write 0x00ff, s_16_w
  step 1
  iters 111
```

This iteration mechanism in the address generation circuitry supports up to four-levels of nested iteration allowing for multi-dimensional arrays to efficiently encode tensors as a short sequence of read or write, or gather or scatter, operations followed by countdown, step, and iter instructions to control the loop bounds. The countdown instruction specifies the inter-loop delay in cycles.

For example, assume a 1 GHz operating frequency of the TSP clock. The stream register bandwidth, B, exported by each MEM interface on the East and West edge of each MEM partition keeps the functional modules adequately fed with data operands in order to saturate the peak arithmetic capacity of the functional modules. The stream registers provide a combined capacity of 20 TiB/s of read (operand) and write (result) bandwidth (a Tib is a Mibyte of Mibytes).

To maximize stream concurrency, the compiler allocates memory for tensors concurrent stream operands into separate MEM slices. As the streams propagate through the MEM system they “pick up” the arguments from the MEM slices enroute to the MXM. The compiler explicitly schedules individual banks of each MEM slice to achieve fine-grain memory management. This enables design patterns and use-cases where simultaneous reading of operands from one bank and writing of results to the other bank in the same slice. As an example, the transpose instruction takes 16 input streams and produces 16 output streams with the rows and columns transposed. By using the bank concurrency available within each MEM slice, it is possible to use the pseudo dual-ported SRAM for dual read/write accesses per slice.

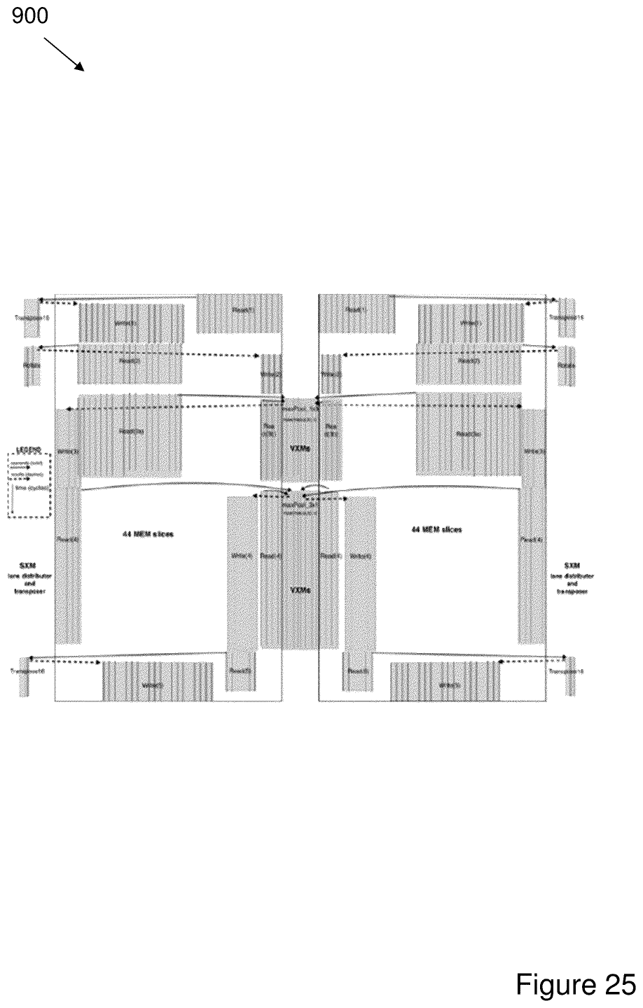

An example of this concurrency is shown in FIG. 25, which shows the different operations (read, write, transpose, rotate, etc.) in a max pooling operation 900. In FIG. 25, the solid lines show operand flow and dotted-line shows result data flow. The 16 concurrent streams are read from memory by Read(1) and sent to the SXM where they undergo a transposition of their elements, and 16 stream results flow back to MEM where they are committed to SRAM by Write(1). In this figure, each operation is preceded by read instructions to provide the stream operands and followed by a write to commit the results back to MEM.

Conventional CPUs rely on a memory hierarchy to implicitly move data between caches to service load/store operations. Cache hierarchies introduce a reactive agent in the data path and the undesired unpredictability, or non-determinism, in the data path to provide the illusion of sequentially consistent memory transactions within the memory hierarchy. The TSP's MEM system is unlike a conventional CPU. Instead, a thin layer of memory management is provided that identifies the memory concurrency on an operation by operation basis. As an example, the Python code below shows the memory management for a transpose operation; an instruction that takes 16 streams as input and creates 16 streams of output. The g.malloc function returns a tensor of addresses allocated across 16 memory slices, one for each concurrent stream:

```
# Read from 16 slices onto 16 slices
# Transpose data
# Write from 16 slices into 16 slices
Import groq as g
tensor = g.random_tensor(shape=[1024, 320],
  dtype=g.Int8, layout=[64, 16])
streams_16 = tensor.read(streams=range(16))
streams_16_t = g.transpose16(streams_16)
out_addres = g.malloc(shape=[1024, 320],
  layout=[64, 16])
streams_16_t.write(out_addrs)
```

The memory units also store VLIW-like instructions, which are 2,304 (144×16) bytes wide. The program fetches instructions when the memory units are otherwise idle; instruction fetches require less than 10% of the total MEM bandwidth. Instructions are decoded and loaded into queues, allowing the program to prefetch. To reduce code size, the REPEAT N instruction repeats the previous instruction N times. Since NOP is the most common instruction, the program can specify it to last for N cycles.

Microprograms

Each functional slice has a predefined set of instructions (e.g., Read, Write, Add, Mul, etc.) that define its supported operations. Furthermore, functional slices consume operands from, and produce results to, streams. A more complex sequence of operations, a microprogram, is composed of one or more slices coordinating in a producer-consumer manner to create one or more output streams. This is accomplished by logically chaining multiple slices together to consume input data from up-stream slices, operating on that data to produce a new result stream, where it later can be consumed by a down-stream slice in a similar manner. In general, each functional slice can choose the direction of its result stream. With this cooperative producer-consumer model operating on data streams, more elaborate operations can chain together different functional slices, for example, where a composite function, F (x, y, z)=MEM(x)→SXM(y)→MXM(z), is an amalgam of several functional slices chained together.

This dataflow composition exploits ‘data flow locality’ by passing the same data across multiple functional slices which can operate on the data to produce some output stream. The output from one functional slice can be transferred to the input of another slice allowing for chaining of operations through a common stream register.

The underlying data type supported by the TSP is a vector. The number of elements in each vector can vary from 16 elements, one Superlane, all the way to 320 elements using all 20 Superlanes on-chip. That is, the minimum vector length, or minVL, is 16 bytes and the maximum vector length, or maxVL is a 320 byte-sized element array. Because the vector length can vary from 16 to 320 elements, instructions configure each tile for a low-power mode to effectively power down any unused Superlane (row of the mesh) and reduce the power consumed. This scalable vector approach allows the vector length to grow from 16 to 320 bytes in 16-lane steps, powering-down the unused tiles, yielding a more energy-proportional system.

The TSP's instruction set architecture provides temporal information about each instruction to allow the compiler precise control of each instruction's dispatch time. Each instruction is augmented with the following temporal parameters:

df unc functional delay—each instruction requires 1 or more cycles to produce its stream output. The df unc timing parameter allows the compiler to reason about when the output of an instruction will be available on the architecturally-visible stream registers.

dskew instruction-operand skew—the timing relationship between the instruction dispatch time relative to when its stream operands are required. The dskew parameter on each instruction informs the compiler how to schedule the operand arrival times with the instruction dispatch time in order to get them to properly intersect in time and space.

The parameters are necessary to track the exact spatial relationship between instructions and operands.

The execution time of an instruction includes the instruction functional delay, and stream propagation (transit) delay to get from stream register location i (S Ri) to j (SRj).

T=N+dfunc+ [symbol] (j,i) (4)

In Equation 4 the time, T, executing an instruction where N is the number of tiles in the functional slice, and df unc is the functional delay of the instruction being executed (cycles) for the output stream to appear on the SRi (stream register at location i in FIG. 4) en route to the consumer at SRj. The transit delay, [symbol] (j,i) is the distance (in cycles) between SRj and SRi.

The TSP programming model relies on two critical elements: (1) scheduling specific data paths in hardware, and (2) exposing temporal information about an instruction's execution latency through the Instruction Set Architecture (ISA), so that the compiler's back-end can precisely track the position and time-of-use of any stream on-chip.

The compiler uses NOP instructions to control the relative timing of the functional slices and the data on which they operate. A NOP has a repeat count 16-bit field which allows one NOP to wait from Ins up to 65 μs for a 1 GHz clock. The NOP instruction is implemented in the ICU's tile and common to all functional slices. The NOP allows the slice to turn off the clock-enable signal when performing no operations for anything longer than a few cycles (e.g.,n>4 cycles).

Each functional slice is independent; however, the compiler keeps track of a logical program time. Conceptually it is similar to a program counter in a conventional CPU, except the compiler tracks the state of 144 independent program queues on a cycle-by-cycle basis. So, at logical time t, the compiler knows the state of each Instruction Queue (IQ) inside each Instruction Control Unit. NOP instructions coordinate the temporal relationship between instructions in the same IQ, or between instructions in different IQs. In addition to repeated-NOPs, a higher-level synchronization across all functional slices on the chip is enabled in order to reason about program correctness, which is the role of the Sync and Notify instructions. They provide a barrier synchronization mechanism across all 144 independent queues on the chip. One IQ is designated as the notifier and it issues a Notify instruction while all other IQs are parked on a Sync instruction. The receipt of the Notify is broadcast to all the IQs to satisfy the pending Sync and begin processing instructions again.

This barrier synchronization is only required once after the TSP resets. However, in practice, each program may start with a set of “preamble” instructions which configure each tile. After that a Sync instruction is performed to ensure that all functional slices are aligned to the same logical time. A chip-wide barrier synchronization can be accomplished in 35 clock cycles, from the time the Notify is issued to the time the Sync is satisfied and retired to allow subsequent instructions to flow. After this compulsory barrier synchronization, the functional slices can compute and communicate results in a synchronization-free manner through the stream registers.

Repeat (n, d) is an ICU instruction issued to repeat a previous instruction n times, with d cycles between each iteration.

.VXM 0
10: max int8 SG4_0_w, SG4_1_w, SG4_0_w
rep 54, 1

In the above example, a max arithmetic function is performed in VXM 0 at (cycle) time 10, and repeating that instruction 54 times, with 1 cycle of delay between each iteration. Allowing variable amounts of delay between iterations allows the compiler to temporally align the repeated instruction with its operands in-flight. This simple but flexible iteration mechanism allows the arithmetic slices, which are often highly iterative, to encode their instructions more efficiently by making better use of main memory and reducing the number of Ifetch instructions compared to if the loop were unrolled.

The Ifetch instruction has a single stream operand which carries the instructions in their program order, filling the IQ with 640-bytes (a pair of 320-byte vectors) of instructions. All functional slices can fetch instructions simultaneously with normal instruction execution. The compiler performs omniscient prefetching of the program's instructions to keep all 144 IQs busy on each cycle by inserting Ifetch instructions into every slices' instruction stream. It is imperative that IQs never are empty so that a precise notion of ‘logical time’ is maintained across the processor.

Data Transfers Between Processor Chips

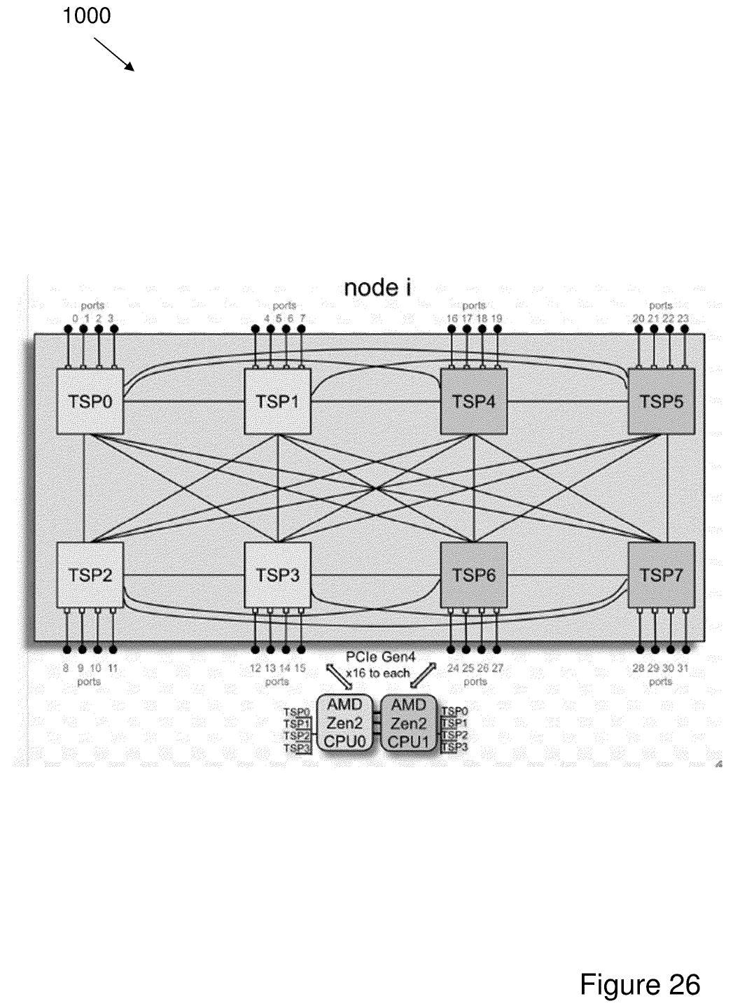

In at least one embodiment, an on-chip network, illustrated in FIG. 26, is used to interconnect cores, or tiles, providing a communication substrate for exchanging data between the tiles. This communication is typically carried out by routing packets among adjacent cores. Typically, packets in the network undergo routing, arbitration, and output port scheduling, and as such often incur conflicts that require arbiters to provide fair access to this shared substrate. Arbiters introduce nondeterminism into the data path and require flow control to avoid overflowing buffer resources. Instead, on each tick of the core clock, the TSP propagates stream values by one stream register hop. The TSP hardware does not track the origin or destination slice, instead streams simply propagate until they fall off the edge of the chip or are overwritten by a functional slice. The TSP uses stream registers within each MEM to move data along a Superlane and uses the SXM to move data between Superlanes. Each instruction specifies one or more source streams-direction pairs, and a target stream and output direction for the result, effectively providing the direction routing of the stream data.

FIG. 26 depicts a network of TSP processors connected via Chip-to-Chip (C2C) modules for at least one embodiment. The processors logically behave as if all chips share a common clock and are connected via time multiplexed wires. TSP chips connected via C2C do not need to share a clock; reasonable alignment of the frequency of the clocks (measured in PPM) will suffice. The receive buffers in the communications modules must be large enough so that the expected PPMs of clocks don't require a realignment more than once per millisecond. If realignments are required more often, then it can become difficult to schedule between model executions.

C2C modules either provide sufficient Forward Error Correction for data transfer between chips such that unrecoverable errors will occur <1 week per chip when using all C2C links, or provide software with a mechanism to add additional redundancy so that errors will occur <1 week per chip when using all C2C links. If error rates are lower at a lower transfer rate (e.g. 16 Gb/s), then SerDes should be able to run at a lower rate for improved precision.

Transfers of data between TSP chips during the compute phase of a program are supported, e.g. while COMPUTE[i].CHIP[A] is running on chip A, it may send data to COMPUTE[i].CHIP[B] on chip B, which may result in data being returned to COMPUTE[i].CHIP[B] and used before the computation completes. This differs from PCIe (Peripheral Component Interconnect express), which only allows data to be transferred before and after a COMPUTE phase.

Alignment of the C2Cs happens once after the system is bootstrapped, therefore it may involve CSRs if this simplifies the process. Realignment for the C2Cs occurs more often, therefore it may not involve CSRs and must execute quickly and in bounded time. C2C communication can be used to send INITs to neighboring TSP chips, or to receive INITs from neighboring TSP chips. C2C links can be used to bootstrap a chip.

Each C2C SerDes is an independent link, e.g., each link may be the only connection to another device or may be one of multiple connections to another device.

Multi-chip systems can be implemented in a variety of topologies for flexible packaging and deployment in rack-scale and cluster scale systems. Communication occurs in a pair-wise manner between a sender port and a receiver port. The sender performs a MEM read to read the address a onto a stream heading toward the SXM. The SXM will perform a Send on the C2C slice representing the physical port where the data is transmitted. On the other side of the link, after a fixed delay for time-of-flight on the wire, the TSP performing the Receive instruction will pull a 320-byte vector off the channel for every Receive issued.

Performance Issues

The number of signals internal to a functional module, and between functional modules is limited by the ‘pitch’ (distance between a pair of wires) which determines the wire density (wire/mm) that can be exploited. For example, a 50 nm pitch, implies a maximum of 20K wires per mm. Obviously, that is using every single available wire, which is never possible, so let's assume 50% utilization of those wires, or 10K per mm. A single Superlane has: (2 directions)×(138 bits per stream)×32 streams=8,832 wires which is <10K/mm as computed above. Across the bisection of the chip, there are (20 Superlanes)×(8,832 wires)=176,640 wires, for an on-chip network capacity of 160 TB/s operating at 900 MHz.

Although the TSP provides 205 teraflop/s for FP16 data (with FP32 accumulators) at 1.0 GHz, it provides four times more INT8 operations than FP16 operations. Some users prefer INT16 or FP16 for inferencing certain models, so the TSP can handle these data types as well. The 220 MB of on-chip memory can hold models as big as Bertbase (110 million parameters); larger models must be divided across multiple TSP chips.

To illustrate operation of the TSP, it is possible to process 20,400 images per second (IPS) for ResNet-50 inference while running the TSP at 900 MHz. If faster inference is required, such as 1,000 TOPS, a higher system clock is required, for example, a 1.25 GHz clock speed.

One advantage of the TSP architecture is that it doesn't require large batches for optimal performance. A single TSP can achieve peak throughput while processing one image at a time. By contrast, other inference devices, using prior art architectures such as a GPU or CPU, require, by way of example, a 128-image batch size.

The Compiler

In at least one embodiment, the TSP uses a compiler on a host computer that analyzes a model (e.g., a machine learning model such as a TensorFlow model) and generates an instruction stream targeting the processor TSP architecture. The compiler coordinates the control and data flow of the program and specifies any instruction-level parallelism by explicitly bundling instructions that can and should execute concurrently so that they are dispatched together. Preferably, synchronization occurs at the start of every program and all data is processed asynchronously because use of the TSP architecture is precisely scheduled over the course of running an entire program, routines or tasks. In some ECINs, the compiler schedules data movement along and among the Superlanes, and schedules instructions for the tiles in each slice. In other ECINs, programmers use an application programming interface to explicitly control the scheduling.

The architecture of the TSP relies on the compiler to handle the complexities associated with instruction scheduling. The scheduling of instructions by the compiler may involve selecting one of several means by which an algorithm is enabled on the functional slices of the processor. Removing the control complexity of dynamic instruction scheduling for multi-issue execution units allows the ICUs to be relatively small, e.g., accounting for less 3% of an area of the processor.

The compiler has access to several architecturally visible functionalities, e.g., (i) the 320-lane programming abstraction, (ii) 144 independent instruction queues (IQs) on-chip, (iii) 64 logical streams per lane, and (iv) 220 MB of globally shared SRAM. Each of the 144 independent on-chip ICUs can issue one or more instructions per clock cycle. The compiler has explicit control of the program order in each instruction queue. The 220 MB of globally shared SRAM may deliver 32 bytes per lane of stream bandwidth and low-latency access to model parameters. For example, MEM can read and MXM can install more than e.g., 100,000 weights into a 320×320 array in less than 30 clock cycles including SRAM and on-chip network transit delays. It should be noted that the values provided herein represent one possible embodiment, and in other embodiments some of these values may differ.

The compiler performs resource allocation in both time and space across the processor, e.g., the compiler solves a two-dimensional (time-space) scheduling of the data flows and the instruction and control flows. The compiler is responsible for exact matching (intersection) in time and space of the data flows with corresponding instruction and control flows.

An instruction set architecture of the processor includes temporal information about each instruction to allow the compiler precise control of each instruction's dispatch time. Each instruction can be augmented with the following temporal parameters: a functional delay (dfunc) and an instruction-operand skew (dskew). Each instruction requires one or more clock cycles to produce its stream output, which represents a functional delay timing parameter. The functional delay timing parameter allows the compiler to determine when an output of an instruction will be available on the architecturally visible STREAMs. The instruction-operand skew parameter can be defined as a timing relationship between the instruction dispatch time relative to when its stream operands are required. An instruction-operand skew parameter for an instruction informs the compiler how to schedule operand arrival times with an instruction dispatch time in order to get them to properly intersect in time and space. The functional delay timing parameter and the instruction-operand skew parameter are necessary to track the exact spatial relationship between instructions and operands in the processor.

An execution time T of an instruction includes a functional delay of the instruction and a stream propagation (transit) delay to flow from STREAM i (SRi) to STREAM j (SRj), e.g., T=N+dfunc+6(j,i), where N is a number of tiles in a functional slice, dfunc is a functional delay of the instruction being executed (e.g., in clock cycles) for an output stream to appear on the SRi, and 8(j,i) is a transit delay distance (e.g., in clock cycles) between the SRj and the SRi.

### DETAILED DESCRIPTION—TECHNOLOGY SUPPORT FROM DATA/INSTRUCTIONS TO PROCESSORS/PROGRAMS

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture. Data and information are physical objects, for example binary data (a ‘bit’, usually signified with ‘0’ and ‘1’) enabled with two levels of voltage in a digital circuit or electronic component. For example, data can be enabled as an electrical, magnetic, optical or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub)routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’).). As used herein, a ‘grammar’ is a set of rules for determining the structure of information. Many forms of knowledge, learning, skills and styles are authored, structured, and enabled—objectively—as processes and/or rules—e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit—such components include resistors, memristors, capacitors, magnetic inductors, crystals, Josephson junctions, transducers, sensors, antennas, waveguides, etc. Active electronic components require a source of energy and can inject energy into a circuit—such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures—such components include switches, relays, protection devices (e.g., fuses, circuit breakers), heat sinks, fans, cables, wires, terminals, connectors and printed circuit boards.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals. How a module is used, its function, can be mostly independent of the physical form in which it is manufactured or enabled.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (‘I/O’) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3DNRML, or MIDI), and any future equivalent programming languages. As used herein, the term ‘source code’ signifies a set of instructions and data specified in text form using a programming language.

As used herein, the term ‘program’ (also referred to as an ‘application program’) signifies one or more processes and data structures that structure a module, processor or computer to be used as a specific machine. One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program and is typically not very accessible to or modifiable by the user of a computer. Computer programs and firmware are often specified using source code written in a programming language, such as C. Modules, circuits, processors, programs and computers can be specified at multiple levels of abstraction, for example, using the SystemC programming language, and have value as products in commerce as taxable goods.

A program can be transferred into one or more memories of the computer or computer system from a data and information device or storage system. A computer system typically has a device for reading storage media that is used to transfer the program, and/or has an interface device that receives the program over a network.

As will be understood, a computer system suitable for supporting embodiments described in this disclosure can include at least one computer which communicates with peripheral devices via bus subsystem. Typically, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem, comprising a memory subsystem and a file storage subsystem, user interface input devices, user interface output devices, and/or a network interface subsystem. The input and output devices enable direct and remote user interaction with the computer system. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program. The computer system typically includes a Basic Input/Output System (BIOS) and processor firmware. The operating system, BIOS and firmware are used by the processor to structure and control any subsystems and interfaces connected to the processor.

Any embodiment is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of a computer system is intended only as an example.

Network interface subsystem provides an interface to outside networks, including an interface to a communication network, and is coupled via communication network to corresponding interface devices in other computer systems or machines. Communication network can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 18 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices 22 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into a computer system or onto a communication network. User interface input devices typically enable a user to select objects, icons, text and the like that appear on some types of user interface output devices, for example, a display subsystem.

User interface output devices can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of a computer system to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

The memory subsystem typically includes a number of memories including a main random-access memory (‘RAM’) (or other volatile storage device) for storage of instructions and data during program execution and a read only memory (‘ROM’) in which fixed instructions are stored. File storage subsystem provides persistent storage for program and data files, and can include a hard disk drive, a floppy disk drive along with associated removable media, a CD-ROM drive, an optical drive, a flash memory such as a USB drive, or removable media cartridges. If the computer system includes an input device that performs optical character recognition, then text and symbols printed on a physical object (such as paper) can be used as a device for storage of program and data files. The databases and modules used by some embodiments can be stored by file storage subsystems.

The bus subsystem provides a device for transmitting data and information between the various components and subsystems of the computer system. Although the bus subsystem is depicted as a single bus, alternative embodiments of the bus subsystem can use multiple buses. For example, a main memory using RAM can communicate directly with file storage systems using Direct Memory Access (‘DMA’) systems.

The memory can include a non-transitory, processor readable data and information storage medium associated with file storage subsystem, and/or with network interface subsystem, and can include a data structure specifying a circuit design. The memory can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light.

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims herein. When an embodiment comprises a particular feature, structure, function or characteristic, it is within the knowledge and understanding of a skilled person to use such feature, structure, function, or characteristic in connection with another embodiment whether or not explicitly described, for example, as a substitute for another feature, structure, function or characteristic.

In view of the Detailed Description, a skilled person will understand that many variations of any embodiment can be enabled, such as function and structure of elements, described herein while being as useful as the embodiment. One or more elements of an embodiment can be substituted for one or more elements in another embodiment, as will be understood by a skilled person. Writings about any embodiment signify its use in commerce, thereby enabling other skilled people to similarly use this embodiment in commerce.

This Detailed Description is written to provide knowledge and understanding. It is neither exhaustive nor limiting of the precise structures described but is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified or incorporated with respect to any one embodiment also can be included with any other embodiment. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any embodiment can have more structure and features than are explicitly specified in the Claims.

What is claimed is:

1. A low latency processing system, comprising
a transformer having an embedding layer; and
a Tensor Streaming Processor (TSP) having a Matrix Multiplication module (MXM) and Vector Calculation module (VXM), with the TSP arranged to deterministically process information arranged by the embedding layer and an encoder layer with the associated self-attention mechanism, the information being further modified according to the transformer using a general matrix multiply (GEMM) mapped directly on the MXM and associated accumulator, and wherein at least some set of information is processed to parallelize the execution of GEMMs across all MXM planes.

2. The low latency data processing system of claim 1, wherein the transformer is a part of a language representation model (LLM).

3. The low latency data processing system of claim 1, wherein the transformer is part of an encoder-based model that uses self-attention mechanisms to generate contextualized representations for input tokens.

4. The low latency data processing system of claim 1, wherein the transformer is a part of an encoder-decoder model that uses both encoder and decoder components.

5. The low latency data processing system of claim 1, wherein the transformer is a part of a decoder model that uses at least one decoder component.

6. The low latency data processing system of claim 1, wherein the encoder layer has multiple encoders and further accepts positional information.

7. The low latency data processing system of claim 3, wherein the self-attention mechanism further comprises multi-head attention modules associated with multiple encoders.

8. The low latency data processing system of claim 7, wherein output from the associated self-attention mechanism is passed to a feed-forward layer and modified using a Gaussian Error Linear Unit (GELU) that can be mapped onto the VXM.

9. The low latency data processing system of claim 1, wherein the TSP further comprises memory modules (MEM) and data path switching modules (SXM), and wherein a vector can be read from the MEM, reordered on the SXM, passed to the MXM for multiplication operation, sent to the VXM, modified by a softmax pass and results written to MEM.

10. The low latency data processing system of claim 1, wherein the TSP is software scheduled.

11. A non-transitory computer-readable storage medium comprising stored computer executable instructions, the instructions which when executed by a compiler operating on at least one computer processor to:
execute a transformer having an embedding layer and an encoder layer with an associated self-attention block; and wherein
the at least one computer processor is a Tensor Streaming Processor (TSP) having a Matrix Multiplication module (MXM) and Vector Calculation module (VXM), with the TSP arranged to deterministically process information arranged by the embedding layer and the encoder layer with the associated self-attention mechanism, the information being further modified according to the transformer using a general matrix multiply (GEMM) mapped directly on the MXM and associated accumulator, and wherein at least some set of information is processed to parallelize the execution of GEMMs across all MXM planes, and
wherein the instructions can be compiled into a binary for execution at the one or more processors, the binary indicating the schedule of execution of the plurality of instructions.

12. A system, comprising:
a compiler configured to determine a schedule of execution of the plurality of instructions for execution by the one or more processors that can execute a transformer having an embedding layer and an encoder layer with an associated self-attention block; and wherein at least one computer processor is a Tensor Streaming Processor (TSP) having a Matrix Multiplication module (MXM) and Vector Calculation module (VXM), with the TSP arranged to deterministically process information arranged by the embedding layer and the encoder layer with the associated self-attention mechanism, the information being further modified according to the transformer using a general matrix multiply (GEMM) mapped directly on MXM and associated accumulator, and wherein at least some set of information is processed to parallelize the execution of GEMMs across all MXM planes, and wherein
the compiler can compile the plurality of instructions into a binary, the binary indicating the schedule of execution of the plurality of instructions; and allow one or more processors to be configured to execute the binary.

13. A method, comprising:
providing a compiler configured to determine a schedule of execution of the plurality of instructions for execution by the one or more processors that can execute a transformer having an embedding layer and an encoder layer with an associated self-attention block; and wherein at least one computer processor is a Tensor Streaming Processor (TSP) having a Matrix Multiplication module (MXM) and Vector Calculation module (VXM), with the TSP arranged to deterministically process information arranged by the embedding layer and the encoder layer with the associated self-attention mechanism, the information being further modified according to the transformer using a general matrix multiply (GEMM) mapped directly on MXM and associated accumulator, and wherein at least some set of information is processed to parallelize the execution of GEMMs across all MXM planes, and wherein
compiling the plurality of instructions into a binary, the binary indicating the schedule of execution of the plurality of instructions; and
allowing one or more processors to be configured to execute the binary.

14. A processing system, comprising
a transformer having an embedding layer and an encoder layer with an associated self-attention block; and
a processor having a memory module, a matrix multiplication module, a data path switching module and a vector calculation module arranged to process information arranged by the embedding layer and the encoder layer with the associated self-attention mechanism, the information being further modified according to the transformer using a pipeline that 1) reads a vector from MEM, 2) reorders the vector on the SXM, 3) multiplies the reordered vector on the MXM, 4) sending the MXM result to a plurality of ALUs to perform a first softmax pass and 5) writing the output of the ALU back to the memory.

15. The data processing system of claim 14, wherein the processing system provides low tail latency when the processor executes instructions of the transformer.

16. The data processing system of claim 15, wherein the processing system schedules instructions and execution of the instructions by the processor has no variation in latency.

17. The data processing system of claim 14, wherein the processing system controls scheduling of execution of processor instructions to hide the latency attributable to non-matrix multiply operations.

18. The data processing system of claim 17, wherein the processor instructions comprise a transformer selected from the group comprising Generative Pre-trained Transformer (GPT), GPT-2, GPT-3, GPT-4, Large Language Model Meta AI (LLaMA), Bidirectional Encoder Representations from Transformers (BERT), XLNet, or RoBERTa.

19. A processing system, comprising
a transformer having an embedding layer and an encoder layer with an associated self-attention block; and
a processor having a memory module, a data path switching module, a matrix multiplication module and a vector calculation module arranged to process information arranged by the embedding layer and the encoder layer with the associated self-attention mechanism, the information being further modified according to the transformer using a pipeline that 1) reads a vector from MEM, 2) reorders the vector on the SXM, 3) multiplies the reordered vector on the MXM, 4) sending the MXM result to a plurality of ALUs to perform a first softmax pass and 5) writing the output of the ALU back to the memory wherein the processing system enables low latency on batch-1 inference by pipelining non-GEMM operations with GEMMs to hide latency induced by executing non-GEMM operations and to hide latency and increase the utilization of the MXM.

20. The processing system of claim 19, wherein the processor optimizes the layer normalization operation to reduce the idle time during which the MXM is waiting for LN results.
